(19) United States
(12) Patent Application Publication
(10) Pub. No.: US 2010/0302487 A1
(43) Pub. Date: Dec. 2, 2010

(54) PHASE COMPENSATION FILM

(76) Inventors: Joey W. Storer, Midland, MI (US); Edward O. Shaffer, II, Midland, MI (US); Leonardo C. Lopez, Midland, MI (US)

Correspondence Address: The Dow Chemical Company, P.O. BOX 1967, Midland, MI, 48641, US

(21) Appl. No.: 12/735,230

(22) PCT Filed: Nov. 24, 2008
(86) PCT No.: PCT/US2008/013076

§ 371 Date: Aug. 13, 2010

Related U.S. Application Data
(60) Provisional application No. 61/009,415, filed on Dec. 28, 2007.

(51) Int. Cl. G02F 1/1335; C09K 19/02; B05D 5/12

(52) U.S. Cl. 349/117; 252/299.01; 427/58

(57) ABSTRACT

The disclosure provides for a phase compensation film that includes nano-particles of a cross-linked polymer with a largest dimension of a quarter of a wavelength of visible light or less, and a liquid crystal substance imbibed substantially throughout the cross-linked polymer of the nano-particles to provide a phase compensation value for a pixel of a liquid crystal display.

### FIELD OF THE DISCLOSURE

The disclosure relates to a phase compensation film, a film forming composition for the phase compensation film, and a method of forming the phase compensation film.

### BACKGROUND

Liquid crystal displays (LCDs), such as LCD televisions, monitors, projectors, and transflective LCDS, can be discolored by both polarizers and liquid crystal cells used in the LCDs. This discoloration can be mitigated by the placement of one or more phase compensation films during the construction of the LCDs. These films are typically made from cellulose triacetate or other semi-crystalline polymers that are biaxially oriented to produce a phase retardation by virtue of their birefringence.

Phase compensation films are also used in LCDs in an attempt to improve viewing angle, contrast ratio, color, color shift, and gray, scale. These improvements are, however, difficult to achieve in a consistent manner across the manufacturing sector due to the variety and propriety of each manufacturer's liquid crystal cell. Further, LCDs that include conventional phase compensation films are highly inefficient; transmitting only 5 to 6 percent of the incident light from a cold cathode fluorescent bulb that acts as a light source for the display. This inefficiency can have significant detrimental effects on battery power consumption in portable devices using liquid crystal displays.

### SUMMARY

Embodiments of the present disclosure include a phase compensation film, a film forming composition for forming the phase compensation film, and a method of forming the phase compensation film.

For the various embodiments, the phase compensation film includes a nano-domain having a cross-linked polymer domain with a largest dimension of a quarter of a wavelength of visible light or less, and a liquid crystal substance imbibed substantially throughout the cross-linked polymer domain of the nano-domain to provide a phase compensation value for the phase compensation film. For the various embodiments, the liquid crystal substance imbibed substantially throughout the cross-linked polymer domain of the nano-domain can provide a phase compensation value for a display or even a pixel of a liquid crystal display. For the various embodiments, the cross-linked polymer domain of the nano-domain imbibed substantially throughout with the liquid crystal substance forms what is referred to herein as a small scale functional material.

The present disclosure also includes embodiments of a film forming composition that include a nano-domain having a cross-linked polymer domain with a largest dimension of 5 nanometers (nm) to 175 nm, a liquid crystal substance imbibed substantially throughout the cross-linked polymer domain of the nano-domain, and a liquid medium, where the liquid medium suspends the nano-domain having the liquid crystal substance substantially throughout the cross-linked polymer domain of the nano-domain.

Embodiments of the present disclosure also include a method that includes applying a film forming composition even down to the level of a pixel of a liquid crystal display, where the film forming composition includes nano-domains each having a cross-linked polymer domain with a largest dimension of 5 nm to 175 nm, a liquid crystal substance imbibed substantially throughout the cross-linked polymer domain of the nano-domains to provide a phase compensation value for the pixel of the liquid crystal display, and a liquid medium, where the liquid medium suspends the nano-domains imbibed therein with the liquid crystal substance.

The embodiments of the present disclosure also include a process for the preparation of the small scale functional material, where the process includes: forming an emulsion of the nano-domains, where each of the nano-domains has the cross-linked polymer domain with the largest dimension of a quarter of a wavelength of visible light or less; and imbibing a functional material substantially throughout the cross-linked polymer domain to produce the small scale functional material that can then be used to create a film that is the phase compensation film. For the various embodiments, the emulsion of nano-domains can be formed in the same phase as the functional material.

For the various embodiments, the functional material imbibed substantially throughout the cross-linked polymer domain can be selected from a liquid crystal substance, a dichroic dye, and combinations thereof. Examples of liquid crystal substances include those with a negative dielectric anisotropy, a positive dielectric anisotropy, a neutral anisotropy, and combinations thereof. For the various embodiments, the liquid crystal substance imbibed substantially throughout the cross-linked polymer domain can also be copolymerized with one or more additional compounds, such as a dichroic dye.

For the various embodiments, an amount of the functional material imbibed substantially throughout the nano-domain can be from about 6 percent by weight to about 60 percent by weight of the small scale functional material. For the various embodiments, the amount of the functional material imbibed substantially throughout the nano-domain can be from about 6 percent by weight to about 30 percent by weight of the small scale functional material.

For the various embodiments, the amount and/or type of the functional material imbibed in the nano-domain can be dependent upon the application of the resulting small scale functional material. For example, in a phase compensation film, the amount and/or type of the liquid crystal substance used may be a function of the device with which the phase compensation film is used. In addition, the amount of the liquid crystal substance imbibed in the nano-domain can also be dependent upon the refractive index and/or birefringence of the liquid crystal substance imbibed in the nano-domain. A phase retardation value of the film forming composition can also be adjusted with a choice of at least one of the liquid crystal substance and/or the amount of liquid crystal substance in the nano-domain, the composition of the nano-domain former and the cross-link density of the nano-domain former.

For the various embodiments, it is also possible to use combinations of two or more of the small scale functional materials in an application, where each of the small scale functional materials can have a different amount and/or type of the functional material. For example, the phase compensation films of the present disclosure can be formed in one or more layers, where each layer has nano-domains with an imbibed liquid crystal substance of different internal birefringence as compared to at least one other layer of the multi-layer film. So, the nano-domains in each layer can contain at least one of a different type of liquid crystal substance and/or a different amount of the liquid crystal substance. To form such a multi-layer film, different film forming compositions each having different phase compensation values can be applied or deposited, where two or more of the layers contain a different liquid crystal substance and/or an amount of the liquid crystal substance. This use of different types and/or amounts of liquid crystal substances may allow for tuning an optical performance of the phase compensation film formed with the small scale functional materials for the desired application. Additionally, this multi-layer film may be useful for improving LCD transmittance by refractive index matching optical elements throughout the system. So, for the various embodiments, a refractive index value of a pixel of a liquid crystal display can be matched with a refractive index of the film forming composition.

For the various embodiments, the phase compensation film of the present disclosure can be used with an LCD. For example, a phase compensation film can have a single uniform configuration with one or more layers for use over the whole of the LCD. Alternatively, the phase compensation film can be configured with one or more layers for two or more of the individual pixels (e.g., at the pixel level) of a LCD, where the film of the present disclosure modifies the performance of the LCD. The phase compensation film of the present disclosure can also help to improve light transmittance of an LCD, where the resulting phase compensation film of the present disclosure can have a transmittance for light of at least 90 percent or greater (as measured with a general purpose CIE-C standard illuminant and with a glass slide as a standard, as will be discussed in the Examples Section below). As will be appreciated, having a more efficient transmittance can have a significant impact with respect to power consumption in portable devices using LCDs.

For the various embodiments, the phase compensation film of the present disclosure can be applied to individual pixels of the LCD. In other words, the film forming compositions used to form the phase compensation film can be applied at, for example, a size scale of a pixel of the LCD. So, for example, it is possible to apply different film forming compositions of the present disclosure in which a first preselected liquid crystal substance imbibed in the nano-domain is applied to a first pixel of the LCD (e.g., a red pixel), a second preselected liquid crystal substance imbibed in the nano-domain is applied to a second pixel of the LCD (e.g., a green pixel) and a third preselected liquid crystal substance imbibed in the nano-domain is applied to a third pixel of the LCD (e.g., a blue pixel), where each of the first, second, and third pixel of the LCD provides a different color. It is also understood that additional preselected liquid crystal substances imbibed in the nano-domain could be applied to additional pixels of other colors (e.g., a fourth pixel of a color that is different than each of the first, second, and third pixel of the LCD). So, for the various embodiments, the nano-domains and liquid crystal substance can provide and control an individual phase compensation value at a pixel level for each of a first pixel, a second pixel, and a third pixel, where each of the first, second, and third pixel of the LCD provides a different color for the liquid crystal display.

For the various embodiments, the liquid crystal substance imbibed substantially throughout the cross-linked polymer domain can also provide a phase compensation value in a range of 2 nm to 1500 nm. In addition, the liquid crystal substance imbibed substantially throughout the nano-domain can remain in a monomeric state, as will be more fully discussed herein.

For the various embodiments, the film forming composition used to form the phase compensation film can include a liquid medium, where the liquid medium suspends the small scale functional material. The liquid medium can be aqueous and/or non-aqueous (e.g., organic). Examples of suitable liquid media include, but are not limited to, toluene, benzene, and mesitylene, among others. Other additives can also be dispersed into the aqueous and/or non-aqueous liquid medium, including more than one of the small scale functional material. The film forming compositions can be applied as discussed herein to form the phase compensation film upon removal (e.g., drying) of the liquid medium.

For the various embodiments, the liquid crystal substance maintains an essentially stable concentration in the cross-linked polymer domain when in the liquid medium. In addition, the film forming composition can have a viscosity of a predetermined value that allows the composition to be applied through a number of different surface coating techniques, such as a thermal jetting, ejection printing, film casting, continuous jetting, piezo jetting, spray coating, and an Ink-Jet printing process. Other techniques for applying the film forming composition of the present disclosure are also possible.

In addition, it has also been discovered that the cross-linked polymer domain of the small scale functional material can also, surprisingly, form a predetermined index ellipsoid once dried in, for example, a phase compensation film. For the various embodiments, the shape of the resulting predetermined index ellipsoid can be a function of the type of the cross-linked polymer domain, a cross-linking density of the cross-linked polymer domain, a type and an amount of liquid crystal substance.

Examples of predetermined index ellipsoid that can be formed with the cross-linked polymer domain of the small scale functional material include: Positive A-plate, Negative A-plate, Positive C-plate, Negative C-plate, Positive Oblique type, Negative Oblique type, Biaxial X-Y optical axis, Biaxial Negative X-Z optical axis, and Biaxial Positive Y-Z optical axis. This surprising result allows for a phase compensation requirement of a pixel of a liquid crystal display to be matched to the phase compensation ability of the phase compensation film. So, for the various embodiments the predetermined index ellipsoid of the cross-linked polymer domain allows the phase compensation film to compensate for an optical performance of a pixel of a liquid crystal display.

In addition to the final shape of the cross-linked polymer domain, other factors that can be used to modify the optical performance of the phase compensation film can include a magnitude of the cross-linked polymer domain, an amount and type of the liquid crystal substance imbibed substantially throughout the cross-linked polymer domain, and/or a thickness of the resulting phase compensation film. So, knowing what predetermined index ellipsoid results from a small scale functional material of the present disclosure, an individual may tune the phase compensation film for a specific LCD technology to improve one or more of a viewing angle, a contrast ratio, color, color shift, and a grey scale performance of the display overall or even down to the level of a pixel.

The level of birefringence in the phase compensation film of the present disclosure may be adjusted by electrically poling (the application of an electrical field across the small scale functional material) the small scale functional material to produce an out-of-plane alignment of the liquid crystal substance. This allows the liquid crystal substance, for example, to produce a refractive index in a Z-direction pointing out of a plane of the phase compensation film that is greater than a refractive index in either of the X-direction and the Y-direction of the plane of the phase compensation film (e.g., a negative C-plate index ellipsoid). This ability to further orient the liquid crystal can add to the level of control and tuneability of the phase compensation film of the current disclosure. For the various embodiments, during the poling process additional cross linking can be conducted on the cross-linked polymer domain (e.g., through the application of UV light) so as to better stabilize the imposed orientation of the liquid crystal substance.

For the various embodiments, the small scale functional material can be dispersed spatially with varying concentration in the phase compensation film to create a gradient of refractive indexes across a thickness of the phase compensation film.

### DEFINITIONS

As used herein, the term “nano-domain” refers to a particle of a cross-linked polymer domain that has a largest dimension of a quarter of a wavelength of visible light or less.

As used herein, the term “visible light” and/or the electromagnetic spectrum in a visible frequency range refers to visible electromagnetic radiation having a wavelength from about 400 nanometers (nm) to about 700 nm.

As used herein, the term “imbibed” refers to a process by which a functional material that responds to an applied field (e.g., electric, electromagnetic, magnetic) is absorbed into and substantially throughout the cross-linked polymer domain of the nano-domain to provide an essentially uniform concentration of the functional material across the cross-linked polymer domain.

As used herein, the term “applied field” refers to an energy that is intentionally applied to the small scale functional material for the purpose of eliciting the functional response from functional material imbibed in the small scale functional material.

As used herein, a “liquid crystal substance” refers to a liquid crystal compound or a mixture of liquid crystal compounds which is formed of two or more different liquid crystal compounds.

As used herein, a “liquid crystal” refers to an elongate molecule having a dipole and/or a polarizable subsistent that can point along a common axis called a director.

As used herein, the term “discrete” refers to a state in which the small scale functional material is mixed into a liquid medium without the cross-linked polymer domain and/or the functional material dissolving and/or leaching into the liquid medium.

As used herein, “negative dielectric anisotropy” includes a state in which a dielectric coefficient parallel to a director is less than a dielectric coefficient perpendicular to the director, where the director refers to a local symmetry axis around which a long range order of a liquid crystal is aligned.

As used herein, the term “dispersed” or “dispersion” refers to distributing the small scale functional material substantially throughout the liquid medium in a predetermined concentration without separation at the macro level.

As used herein, the term “copolymer” refers to a polymer produced through the polymerization of two or more different monomers.

As used herein, “liquid” refers to a solution or a neat liquid (a liquid at room temperature or a solid at room temperature that melts at an elevated temperature).

As used herein, the term “volume mean diameter” refers to a volume weighted mean diameter of an assembly of cross-linked polymer domain particles: Dᵥ=E{vₓDₓ} where Dᵥ is the volume mean diameter, vₓ is the volume fraction of particles with diameter Dₓ. Volume mean diameter is determined by hydrodynamic chromatography as described in “Development and application of an integrated, high-speed, computerized hydrodynamic chromatograph.” Journal of Colloid and Interface Science, Volume 89, Issue 1, September 1982, Pages 94-106; Gerald R. McGowan and Martin A. Langhorst, incorporated herein by reference in its entirety.

As used herein, the term “film” refers to a continuous sheet (e.g., without holes or cracks) that is from about 50 micrometers to about 1 micrometer in thickness and of a substance formed with the small scale functional material that may or may not be in contact with a substrate. The thin continuous sheet of the film may be formed from one or more layers of the substance formed with the small scale functional material, where each of the layers may be formed of the same substance formed with the small scale functional material, two or more different substances formed with the small scale functional material, or different combinations of substances formed with the small scale functional material.

As used herein, “LCD” is an abbreviation for liquid crystal display and includes inherently, other displays technologies like LCD-Projectors, and transflective displays.

As used herein, “PDLC” is an abbreviation for polymer-dispersed liquid crystals.

As used herein, “PMMA” is an abbreviation for polymethyl methacrylate.

As used herein, “MMA” is an abbreviation for methyl methacrylate.

As used herein, “DPMA” is an abbreviation for dipropyleneglycol methyl ether acetate.

As used herein, “T_{g}” is an abbreviation for glass transition temperature.

As used herein, “UV” is an abbreviation for ultraviolet.

As used herein, “IR” is an abbreviation for infrared.

As used herein, “GRIN” is an abbreviation for gradient-index.

As used herein, “LED” is an abbreviation for a light emitting diode.

As used herein, “S” is an abbreviation for styrene.

As used herein, “EGDMA” is an abbreviation for ethylene glycol dimethacrylate.

As used herein, “DVB” is an abbreviation for divinylbenzene.

As used herein, “SDS” is an abbreviation for sodium dodecyl sulfate salt.

As used herein, “BA” is an abbreviation for butyl acrylate.

As used herein, “AMA” is an abbreviation for allyl methacrylate.

As used herein, “APS” is an abbreviation for ammonium persulfate.

As used herein, “TMEDA” is an abbreviation for N,N,N′,N′-tetramethylethylenediamine.

As used herein, “MEK” is an abbreviation for methyl ethyl ketone.

As used herein, “THF” is an abbreviation for tetrahydrofuran.

As used herein, “UPDI” is an abbreviation for ultra pure deionized.

As used herein, “PVC” is an abbreviation for polyvinyl chloride.

As used herein, “C-V” is an abbreviation for capacitance-voltage.

As used herein, “Al” is an abbreviation for the element aluminum.

As used herein, “TOL” is an abbreviation for toluene.

As used herein, “V” is an abbreviation for volt.

As used herein, “E-O” is an abbreviation for electro-optical.

As used herein, “CHO” is an abbreviation for cyclohexanone.

As used herein, “RI” is an abbreviation for refractive index.

As used herein, “APE” is an abbreviation for alkylphenol ethoxylates.

As used herein, “AE” is an abbreviation for alcohol ethoxylates.

As used herein, “wt.” is an abbreviation for weight.

As used herein “nm” is an abbreviation for nanometer.

As used herein “μm” is an abbreviation for micrometer.

As used herein “g” is an abbreviation for gram.

As used herein “° C.” is an abbreviation for degrees Celsius.

As used herein “FTIR” is an abbreviation for Fourier Transform Infrared Spectroscopy.

As used herein, “a,” “an,” “the,” “at least one,” and “one or more” are used interchangeably. The terms “comprises” and variations thereof do not have a limiting meaning where these terms appear in the description and claims. Thus, for example, a small scale functional material that comprises “a” functional material having a functionality responsive to an applied field can be interpreted to mean that the functional material includes “one or more” functional materials.

As used herein, the term “dry” means a substantial absence of liquids.

The term “and/or” means one, more than one, or all of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### SUMMARY OF THE FIGURES

FIG. 1 is a graph illustrating a size distribution of nano-domains of the present disclosure.

FIGS. 2A-2C provide FTIR spectra of A) Licristal® E44 (Merck, KGaA, Darmstadt Germany); B) the nano-domains of Example 1; and C) the nano-domains of Example 1 imbibed with Licristal® E44.

FIG. 3 illustrates X-ray scattering patterns of the nano-domains of Example 1 imbibed with various liquid crystal substances.

FIG. 4 illustrates X-ray scattering patterns of the nano-domains of Example 3 imbibed with various liquid crystal substances.

FIGS. 5A and 5B illustrate an amount of liquid crystals imbibed in the nano-domains as a function of the concentration of the liquid crystal substance Licristal® E44 in the methylene chloride precursor solution for various acetone/Licristal® E44 weight ratios (FIG. 5A) and acetone to Licristal® E44 weight ratio in the precursor solution for various concentrations of Licristal® E44 in the precursor solution (FIG. 5B).

FIG. 6 illustrates the results of a least square fit model of the amount of liquid crystal substance in dry nano-domains of the present disclosure.

FIG. 7 illustrates X-ray scattering patterns of different materials with a liquid crystal substance of the present disclosure.

FIG. 8 illustrates the amount of Licristal® E44 imbibed in nano-domains of the present disclosure at various temperatures.

FIG. 9 illustrates the results of a least square fit model of the amount of Licristal® E44 imbibed in nano-domains of the present disclosure at various temperatures.

FIG. 10 illustrates X-ray scattering patterns of different size nano-domains of the present disclosure imbibed with Licristal® E44.

FIG. 11 illustrates X-ray scattering patterns of nano-domains of different composition according to the present disclosure imbibed with Licristal® E44.

### DETAILED DESCRIPTION

Embodiments of the present disclosure provide a phase compensation film, a composition for forming the phase compensation film, and methods of forming the phase compensation film. For the various embodiments, the phase compensation film and the composition for forming the phase compensation film can be used to modify the performance of a liquid crystal display (LCD), where the phase compensation film can be tuned to the unique optical requirements of the LCD. For the various embodiments, the phase compensation film of the present disclosure can be applied at and tailored to either the whole LCD or each individual pixel of the LCD (e.g., selectively compensate each of the color pixels to even colors in the LCD).

The LCD can include, among other things, polarizing films and phase compensation films to help minimize light leakage from the LCD over a wide range of viewing angles. Phase compensation films also help to compensate for variations over angles in the phase differences between orthogonal polarized components of the light wave in the liquid crystal substance layer. Compensation films also help to improve the contrast ratio over the horizontal and vertical viewing angles of the LCD.

Because most liquid crystal substances used in LCDs are positively birefringent, the phase compensation films used with these LCDs have a negative birefringence. A number of approaches have been used in forming phase compensation films having a negative birefringence. One approach has been to biaxially stretch positive birefringence polymeric films made of, for example, polyvinyl alcohol, polycarbonate, and polysulfone to produce the negative birefringence with normal optic axis. One major problem with this approach is bowing during the biaxial stretching, which can render the film defective. Other approaches for forming compensation films for LCDs include solvent casting (e.g., casting of cellulose triacctate films). Films produced using solvent casting, however, can suffer from inhomogeneous trans-esterification that can result in globular defects that cause optical defects in the display.

The embodiments of the present disclosure provide for a phase compensation film, a composition for forming the phase compensation film, and methods of forming the phase compensation film of the present disclosure. For the various embodiments, the phase compensation film includes a small scale functional material that includes a nano-domain having a cross-linked polymer domain with a largest dimension of a quarter of a wavelength of visible light or less, and a liquid crystal substance imbibed substantially throughout the cross-linked polymer domain to provide a phase compensation value for a pixel of a liquid crystal display. For the various embodiments, the liquid crystal substance imbibed substantially throughout the cross-linked polymer domain can provide a phase compensation value in a range of 2 nanometers (nm) to 1,500 nm.

For the various embodiments, the liquid crystal substance imbibed substantially throughout the small scale functional material remains in its monomeric state. This is in contrast to a tendency of liquid crystal molecules to self-organize into large structures. Surprisingly, the embodiments of the present disclosure do not encounter these issues. Rather, self-organization of the liquid crystal substance imbibed substantially through out the nano-domain of the small scale functional material is believed to be minimized. While not wishing to be bound by theory, a possible reason for the minimal self-organization is that the structure of the cross-linked polymer domain helps to minimize the ability of the liquid crystal substance to organize to the extent that it becomes too associated with itself (e.g., so that it does not become too large).

Use of the small scale functional material of the present disclosure may help to address some of the problems found in preparing phase compensation films. First, the small scale functional material of the present disclosure can be prepared as a film forming composition that can be cast, solution cast, and/or spray coated, among other techniques, to form the phase compensation film that can achieve variable phase compensation performance. The flexibility of the methods available to form the phase compensation film allows for a manufacturing performance attribute in the phase compensation marketplace otherwise limited to bulk material properties and film stretching processes. Second, the small scale functional material of the present disclosure can be used to exhibit differentiating performance in the phase compensation film by virtue of the nature of the exact liquid crystal substance or refractive index modifier that is imbibed in the small scale functional material used in forming the phase compensation film. Third, the phase compensation film that results from the small scale functional material can be clear with a very low haze and can exhibit a uniform optical characteristic which can be a significant advantage over incumbent materials.

The phase compensation film of the present disclosure can be used to improve color, color shift, gray scale, and wide viewing angle in LCDs. LCDs do not exhibit the same uniformity of image with viewing angle as does a cathode ray tube display. The phase compensation film of the present disclosure seeks to provide improved viewing angle characteristics in LCDs. These viewing angle characteristics include the variation with angle of the color, the contrast ratio, color, color shift, and a gray scale performance of the display.

The transmittance of the phase compensation film of the present disclosure can also be 90 percent or greater. The high transmittance can significantly impact the light and power efficiency of a LCD that often use many phase compensation films each, for example, on the order of tens to hundreds of micrometers thick. Often, films for phase compensation can contain many layers of materials that are refractive index mis-matched. These films suffer from Fresnel reflections due to index mis-match and are therefore limited in final transmittance. The consequence of the reduced light transmittance is an ever increasing demand on the output of the backlight. The refractive index modified film of the present disclosure may significantly improve LCD overall transmittance through index matching various components (especially glass to polymer). This may be an advantage as it can serve to reduce power consumption in the LCD. The above mentioned Fresnel reflection is an issue that is also addressed in at least two ways by the present disclosure. First, embodiments of the present disclosure can produce birefringent films that have a wide variety of phase retardation values (phase retardation=film birefringence×film thickness). The consequence of this performance may be to reduce the need for additional phase compensation films and to present a phase compensation film with a much reduced thickness as compared to the conventional films. Second, the small scale functional material used for phase compensation film of the present disclosure can be applied in layers where each layer contains a preselected type and an amount (percent by weight of the small scale functional material) of liquid crystal substance. The consequence of this flexibility in materials design enables the formation of interlayers of gradient refractive index materials that are useful for refractive index matching between layers or between substrates (e.g., between polymer and glass or polymer and transparent conductor). Thus, the phase compensation film of the present disclosure may prove useful for refractive index matching and improvement of the performance of layers of optical materials.

The phase compensation film of the current disclosure may also be useful for LCDs that are constructed from and/or are described by the following list of technologies: twisted nematic (TN), super twisted nematic (STN), in-plane switching (IPS), vertically aligned (VA), and multidomain vertically aligned (MVA) and others.

The small scale functional material of the present disclosure may also provide a unique and high degree of control to provide phase compensation at a pixel-level to correct for phase retardation mis-match due to optical dispersion in incumbent films. So, for the various embodiments, a refractive index value of a pixel of a liquid crystal display can be matched with a refractive index of the film forming composition. For example, pixels in LCDs may benefit from individual phase compensations that are directed to each of the red, green, and blue pixels (this is because phase compensation is wavelength dependent). So, color filters for LCDs may now incorporate phase compensation at the pixel level. This in turn may eliminate the need for multiple layers of conventional phase compensation films.

For the various embodiments, multiple layers of the small scale functional material may also be used to achieve a differentiated performance that can include a combination of internal birefringence (for a layer) and the optical advantages of a multi-layer film. In addition, the liquid crystal substance imbibed small scale functional material can form films that do not require a templating step, an orientation step (to produce birefringence), or an alignment or special treatment step like capping.

The phase compensation film of the present disclosure may also utilize polymerizable liquid crystal substances (e.g., polymerizable discotic liquid crystals) within the structure of the polymeric nano-bead prior to imbibing liquid crystal substance monomer. The copolymerization of liquid crystal substance monomers and dichroic dye monomers directly into the structure of the nano-domain is also possible and could provide advantages toward pre-organizing the liquid crystal molecules once they are imbibed or providing different inherent phase compensating performance to the small scale functional material. For the various embodiments, the liquid crystal substance imbibed substantially throughout the cross-linked polymer domain can also be copolymerized with one or more additional compounds (e.g., to modify glass transition temperature).

In addition, it has also been discovered that the cross-linked polymer domain of the small scale functional material can, surprisingly, form a predetermined index ellipsoid once in, for example, a phase compensation film. For the various embodiments, the shape of the resulting predetermined index ellipsoid can be a function of the type of the cross-linked polymer domain, a cross-linking density of the cross-linked polymer domain, and/or a type and an amount of imbibed liquid crystal substance. Examples of the predetermined index ellipsoid are discussed herein.

In addition to the phase compensation film, the small scale functional material of the present disclosure can be used in other optical applications. Such applications include, but are not limited to, gradient refractive index applications ranging from photocopiers to endoscopic lenses to opthalmics. Fiber optic communications and multiplexing of optical signals including beam steering applications can benefit from a highly variable material like the small scale functional material of the present disclosure to tune unique optical designs, telescopes, and instruments in microscopy and imaging. Lenses that are very hard to form with conventional materials including difficult to grind shapes can also be advantaged by the birefringent film formed with the small scale functional material of the present disclosure.

Embodiments of the present disclosure allow for, the small scale functional materials to be used in forming the phase compensation film that contains a large volume fraction of the small scale functional materials. Embodiments of phase compensation film can be formed of a composition of the small scale functional material in which the vast majority of the volume fraction of the composition is the small scale functional material. Suitable values for the vast majority can include at least 60 percent volume fraction of the composition being the small scale functional material, where the remaining volume fraction can include a liquid medium used to suspend the small scale functional material. The liquid medium can be aqueous and/or non-aqueous (e.g., organic). Other volume fractions of the small scale functional material (e.g., 70 percent and greater, 80 percent and greater) are also possible.

For the various embodiments, the liquid crystal substance maintains an essentially stable concentration in the cross-linked polymer domain when in the liquid medium. In other words, the liquid crystal substance imbibed in the nano-domain resists leaching from the nano-domain. In addition, the film forming composition can have a viscosity equal to a predetermined value that can allow the composition to be uniformly applied through a number of different surface coating techniques, such as thermal jetting, ejection printing, film casting, continuous jetting, piezo jetting, spray coating, spin coating, electrostatic coating, and Ink-Jet printing. Other techniques for applying the film forming composition of the present disclosure are also possible.

According to the various embodiments, the small scale functional material is assembled from a nano-domain of a cross-linked polymer and functionalized with a liquid crystal substance, a dichroic dye, or combinations thereof. For the various embodiments, the cross-linked polymer of the nano-domain has a cross-linked polymer domain with a largest dimension of a quarter of a wavelength of visible light or less. These values can include, but are not limited to, a particle size distribution in which the volume mean diameter of the nano-domain is from about 5 nm to about 175 nm. For the various embodiments, the nano-domain can have a volume mean diameter from about 10 nm to about 100 nm.

Embodiments of the present disclosure also provide a method for forming the nano-domain. For example, the nano-domain can be formed through an emulsion process in which each of the nano-domains has a largest dimension as discussed herein (e.g., a quarter of a wavelength of visible light or less) (see, e.g., Kalantar et al., U.S. Publication Nos. 2004/0054111 and 2004/0253442, which are both incorporated herein by reference in their entirety).

For the various embodiments, the emulsion process includes emulsifying a monomer mixture and a surfactant in an aqueous phase. For the various embodiments, the emulsion is a microemulsion of stabilized nano-domains in the aqueous phase. Suitable examples of surfactants include, but are not limited to, polyoxyethylenated alkylphenols (alkylphenol “ethoxylates” or APE); polyoxyethylenated straight-chain alcohols (alcohol “ethoxylates” or AE); polyoxyethylenated secondary alcohols, polyoxyethylenated polyoxypropylene glycols; polyoxyethylenated mercaptans; long-chain carboxylic acid esters; glyceryl and polyglyceryl esters of natural fatty acids; propylene glycol, sorbitol, and polyoxyethylenated sorbitol esters; polyoxyethylene glycol esters and polyoxyethylenated fatty acids; alkanolamine condensates; alkanolamides; alkyl diethanolamines, 1:1 alkanolamine-fatty acid condensates; 2:1 alkanolamine-fatty acid condensates; tertiary acetylenic glycols; polyoxyethylenated silicones; n-alkylpyrrolidones; polyoxyethylenated 1,2-alkanediols and 1,2-arylalkanediols; alkyl polyethoxylates, alkyl aryl polyethoxylates, alkylpolyglycosides, and combinations thereof. Use of ionic surfactants is also possible.

Examples of commercially available surfactants include Tergitol™ and Triton™ surfactants, both from The Dow Chemical Company. The amount of surfactant used can be sufficient to at least substantially stabilize the formed nano-domains in the water or other aqueous polymerization medium. This precise amount will vary depending upon the surfactant selected as well as the identity of the other components. The amount will also vary depending upon whether the reaction is run as a batch reaction, semi-batch reaction or as a continuous reaction. Batch reactions will generally include the highest amount of surfactant. In semi-batch and continuous reactions surfactant will become available again as the surface to volume ratio decreases as particles grow, thus, less surfactant may be needed to make the same amount of particles of a given size as in a batch reaction. The surfactant:monomer weight ratios of from 3:1 to 1:20, and from 2.5:1 to 1:15, are useful. The useful range may in fact be broader than this.

The aqueous phase component may be water or may be a combination of water with hydrophilic solvents or may be a hydrophilic solvent. The amount of aqueous phase used can be at least 40 percent by weight based on the total weight of the reaction mixture. For the various embodiments, the amount of aqueous phase used can be at least 50 percent by weight based on the total weight of the reaction mixture. For the various embodiments, the amount of aqueous phase used can be at least 60 percent by weight based on the total weight of the reaction mixture. The amount of aqueous phase used can also be no greater than 99 percent by weight, no greater than 95 percent by weight, no greater than 90 percent by weight, and/or no greater than 85 percent by weight, based on the total weight of the reaction mixture.

The initiator may be a free radical initiator. Examples of suitable free radical initiators include 2,2′-azobis (2-amidinopropane) dihydrochloride, for example, and redox initiators, such as H₂O₂/ascorbic acid or tert-butyl hydroperoxide/ascorbic acid, or oil soluble initiators such as di-t-butyl peroxide, t-butyl peroxybenzoate or 2,2′-azoisobutyronitrile, or combinations thereof. The amount of initiator added can be from 0.01 to 5.0, from 0.02 to 3.0, or from 0.05 to 2.5 parts by weight per 100 parts by weight of monomer. Other initiators are possible. In addition to the use of free radical initiators, other mechanisms for polymerization include, but are not limited to, curing with ultraviolet light.

The monomer used in forming the nano-domain can be one or more monomers capable of undergoing free radical polymerization. Suitable monomers include those containing at least one unsaturated carbon to carbon bond and/or more than one carbon to carbon double bond. A single type of monomer may be used or two or more different types of monomers may be used in forming the nano-domain.

Examples of suitable monomers can be selected from the group consisting of styrenes (such as styrene, alkyl substituted styrenes, aryl-alkyl substituted styrenes, alkynylaryl alkyl substituted styrenes, and the like); acrylates and methacrylates (such as alkyl acrylates or alkyl methacrylates and the like); vinyls (e.g., vinyl acetate, alkyl vinyl ether and the like); allyl compounds (e.g., allyl acrylate); alkenes (e.g., butene, hexene, heptene, etc.), alkadienes (e.g., butadiene, isoprene); divinylbenzene or 1,3-diisopropenylbenzene; alkylene glycol diacrylates and combinations (e.g., mixtures for producing copolymers) thereof. As used herein, the term “alkyl” can include a saturated linear or branched monovalent hydrocarbon group having from 4 to 14 carbons (C4-C14). As used herein, the term “alkenes” can include an unsaturated hydrocarbon having at least one carbon-carbon double bond having from 4 to 14 carbons (C4-C14).

For the various embodiments, the nano-domain can be formed from monomers of methyl methacrylate (MMA) and butyl acrylate. For the various embodiments, the nano-domain can be formed from MMA, butyl acrylate, and styrene monomers. Other copolymer configurations for the nano-domain are also possible.

In addition, monomers of liquid crystal polymers can be used in forming the nano-domain of the present disclosure. Such monomers can include partially crystalline aromatic polyesters based on p-hydroxybenzoic acid and related monomers. Specific examples of monomers that can be polymerized to form nano-domain with co-polymerized liquid crystalline functionality include 2-propenoic acid, 4′-cyano[1,1′-biphenyl]-4-yl ester; cholest-5-en-3-ol (3β), 2-propenoate; benzoic acid, 4-[[[4-[(1-oxo-2-propenyl)oxy]butoxy]carbonyl]oxy], 2-methyl-1,4-phenylene ester; benzoic acid, 3,4,5-tris[[11]-[(1-oxo-2-propen-1-yl)oxy]undecyl]oxy], sodium salt (1:1); phenol, 4-[2-(2-propen-1-yloxy)ethoxy]; [1,1′-biphenyl]-4-carbonitrile, 4′-(4-penten-1-yloxy); phenol, 4-(10-undecenyloxy); benzoic acid, 4-[2-(2-propenyloxy)ethoxy]; 1,4-cyclohexanedicarboxylic acid, bis[4-(10-undecenyloxy)phenyl]ester, trans; benzoic acid, 4-[[6-[(1-oxo-2-propenyl)oxy]hexyl]oxy]-, 2-chloro-1,4-phenylene ester; and benzoic acid, 4-[[6-[(1-oxo-2-propenyl)oxy]hexyl]oxy]-, 2-chloro-1,4-phenylene ester, homopolymer.

According to various embodiments, the nano-domain is cross linked through the use of ultraviolet light or a radical initiated cross-link process. Cross linking of the nano-domain can occur either before and/or after imbibing of the functional material. In such embodiments at least some of the monomers will have more than one unsaturated carbon to carbon bond. Using a styrene monomer with divinylbenzene or 1,3-diisopropenylbenzene is a useful embodiment. An amount of crosslinking monomer (e.g., the monomer having more than one carbon to carbon double bond available for reaction) used can be less than about 100, less than about 70, less than about 50 percent by weight based on the total weight of monomers and greater than about 1, or greater than about 5 percent by weight. The total amount of monomers added to the composition is in the range from about 1 to about 65, from about 3 to about 45, or from about 5 to about 35 percent by weight based on total weight of the composition.

The processes used to make the nano-domains of the present disclosure may be run as a batch process, as a multi-batch process, as a semi-batch process, or as a continuous process, as discussed in Kalantar et al., U.S. Publication Nos. 2004/0054111 and 2004/0253442. Suitable reaction temperatures are in the range of about 25° C. to about 120° C.

Once formed, the nano-domains may be precipitated by mixing the emulsion with an organic solvent or solvent mixture that is at least partially soluble in water, and in which resulting aqueous phase-solvent mixture, the formed polymer is substantially insoluble. Examples of such solvents include, but are not limited to, acetone, methyl ethyl ketone, and methanol. This step precipitates the nano-domains, which can be used dry or be redispersed in a suitable organic solvent such as gamma butyrolactone, tetrahydrofuran, cyclohexanone, mesitylene, or dipropyleneglycol methyl ether acetate (DPMA) for subsequent use. Precipitation is also useful in removing a substantial amount of the surfactant residue from the nano-domains.

The nano-domains may also be purified by a variety of methods as are known in the art such as passing through a bed of ion exchange resin prior to precipitation; precipitating and washing thoroughly with deionized water and optionally with a solvent in which the nano-domains are insoluble; and precipitating, dispersing the nano-domains in an organic solvent and passing the dispersion through a silica gel or alumina column in that solvent.

After precipitation, a spray drying step may be used to form a powder of the nano-domains, where the drying temperature is not high enough to cause residual reactive groups on the nano-domains to react and cause agglomeration and an increase in nano-domains particle size. Lyophilization may be used to form the powder of the nano-domains.

Other methods for forming the nano-domains for the present disclosure are also possible. Examples include those described by Mecerreyes, et al. Adv. Mater. 2001, 13, 204; Funke, W. British Polymer J. 1989, 21, 107; Antonietti, et al. Macromolecules 1995, 28, 4227; and Gallagher, et al. PMSE. 2002, 87, 442; Gan, et al. Langmuir 2001, 17, 4519.

For the various embodiments, the nano-domain can be functionalized by imbibing a liquid crystal substance substantially throughout the cross-linked polymer domain to form the small scale functional material. For the various embodiments, imbibing the liquid crystal substance substantially throughout the cross-linked polymer domain of the nano-domains can occur either after and/or during the formation of the cross-linked polymer domain.

For the various embodiments, the cross-linked polymer domain has a structure that provides a contiguous substantially uniform network that extends through the cross-sectional dimensions of the nano-domain (e.g., it is a solid particle having a tortuous porous network). For the various embodiments, the porosity of the structure allows the liquid crystal substance to be imbibed into the nano-domain structure. In other words, the cross-linked polymer domain can act like a sponge to imbibe and retain the liquid crystal substance. This structure is in contrast to a shell, for example, that holds a volume of the functional material.

For the various embodiments, the liquid crystal substance can disperse uniformly substantially throughout the cross-linked polymer domain of the nano-domain. This allows for an essentially uniform concentration of the liquid crystal substance through the nano-domain regardless of the location within and/or across the cross-linked polymer domain. In addition, the porosity of the nano-domain is such that the liquid crystal substance can also maintain an essentially stable concentration in the cross-linked polymer domain when in solution.

For the various embodiments, the amount of the liquid crystal substance used or imbibed in the nano-domain can be dependent upon the application of the resulting small scale functional material. So, for example, if the application is for a compensation film of a LCD, the amount of the liquid crystal substance used will be a function of the desired LCD. In addition, the amount of the liquid crystal substance imbibed in the nano-domain can also be dependent upon the anisotropy, the refractive index and/or the birefringence of the liquid crystal substance imbibed in the nano-domain. For the various embodiments, the amount of liquid crystal substance imbibed into the nano-domains can range from about 6 percent by weight to about 60 percent by weight of the small scale functional material. In addition, the liquid crystal substance can have a refractive index value that is greater than the refractive index value of the cross-linked polymer domain.

For the various embodiments, the amount and/or type of the liquid crystal substance imbibed in the nano-domain can be dependent upon the application of the resulting small scale functional material. The amount of the liquid crystal substance imbibed in the nano-domain can also be dependent upon the refractive index and/or birefringence of the liquid crystal substance imbibed in the nano-domain. So, a phase retardation value of the film forming composition can be adjusted with at least one of the liquid crystal substance and the amount of liquid crystal substance in the nano-domain.

For the various embodiments, it is also possible to use combinations of two or more of the small scale functional materials in an application, where the small scale functional materials can have different types and/or amounts of the liquid crystal substance. For example, the phase compensation film of the present disclosure can be formed in two or more layers (e.g., a multi-layer film) that each has nano-domains with imbibed liquid crystal substances of different internal birefringence as compared to the other layers of the film. For example, it would be possible to have a film having a first layer of the small scale functional material that contains a first nano-domain functionalized with a first liquid crystal substance at a first predetermined amount and a second nano-domain (different than the first nano-domain) functionalized with a second liquid crystal substance (different than the second liquid crystal substance) at a second predetermined amount (different than the first predetermined amount). Using this approach, or others, it would be possible to “tune” a resulting multi-layer film for a desired application.

For the various embodiments, the phase compensation film of the present disclosure can be applied to individual pixels of the LCD. In other words, the film forming composition used to form the phase compensation film can be applied at, for example, a size scale of a pixel of the LCD. So, for example, it would be possible to apply different film forming compositions of the present disclosure in which a first preselected liquid crystal substance in the nano-domain was applied to a first pixel of the LCD (e.g., a red pixel), a second preselected liquid crystal substance in the nano-domain was applied to a second pixel of the LCD (e.g., a green pixel) and a third preselected liquid crystal substance in the nano-domain was applied to a third pixel of the LCD (e.g., a blue pixel). As appreciated, there can be other pixel colors in addition to the red, blue, and green discussed herein. So, for the various embodiments, the nano-domains and liquid crystal substance can provide and control an individual phase compensation value at a pixel level for correction of one of the red pixel, the green pixel, and the blue pixel of the liquid crystal display.

Examples of liquid crystal substances suitable for imbibing into the nano-domain of the small scale functional material include those in an isotropic phase, a nematic phase, a twisted nematic phase, a smectic phase, a chiral nematic phase, and/or a discotic phase. For the various embodiments, suitable liquid crystal substances can include, but are not limited to, 4-Pentylphenyl 4-pentylbenzoate; 4-Pentylphenyl 4-methoxybenzoate; 4-Pentylphenyl 4-methylbenzoate; 4-Pentylphenyl 4-octyloxybenzoate; 4-Pentylphenyl 4-propylbenzoate; 2,5-Dimethyl-3-hexyne-2,5-diol; 644-(4-Cyanophenyl)phenoxy]hexyl methacrylate; Poly(4-hydroxy benzoic acid-co-ethylene terephthalate); p-Acetoxybenzylidene p-Butylaniline; p-Azoxyanisole; 4,4′-Azoxydiphenetole; Bis(p-Butoxybenzylidene) a,a′-Bi-p-toluidine; Bis(p-heptyloxybenzylidene) p-Phenylenediamine; Bis(p-octyloxybenzylidene) 2-Chloro-1,4-phenylenediamine; p-Butoxybenzoic Acid; p-Butoxybenzylidene p-Butylaniline; p-Butoxybenzylidene p-Ethylaniline; p-Butoxybenzylidene p-Heptylaniline; p-Butoxybenzylidene p-octylaniline; p-Butoxybenzylidene p-Pentylaniline; p-Butoxybenzylidene p-Propylaniline; Butyl p-Hexyloxybenzylidene p-Aminobenzoate; Cholesteryl Benzoate; Cholesteryl Decanoate (Caprate); Cholesteryl dodecanoate (Laurate); Cholesteryl Elaidate; Cholesteryl Erucate; Cholesteryl Ethyl Carbonate; Cholesteryl Heptanoate (Enanthate); Cholesteryl Hexadecyl Carbonate; Cholesteryl Methyl Carbonate; Cholesteryl Octanoate (Caprylate); Cholesteryl Oleyl Carbonate; Cholesteryl Pentanoate (Valerate); Cholesteryl Tetradecanoate (Myristate); p-Cyanobenzylidene p-Nonyloxyaniline; 4-Cyano-4′-butylbiphenyl; 4-Cyano-4′-hexylbiphenyl; 4-Cyano-4′-octylbiphenyl; 4-Cyano-4′-pentylbiphenyl; 4-Cyano-4′-pentyloxybiphenyl; p-Decyloxybenzoic Acid; p-Decyloxybenzylidene p-Butylaniline; p-Decyloxybenzylidene p-Toluidine; Dibenzylidene 4,4′-Biphenylenediamine; 4,4′-Diheptylazoxybenzene; 4,4′-Diheptyloxyazoxybenzene; 4,4′-Dihexylazoxybenzene; 4,4′-Dihexyloxyazoxybenzene; 4,4′-Dihexyloxyazoxybenzene; 4,4′-Dinonylazoxybenzene; 4,4′-Dioctylazoxybenzene; 4,4′-Dipentylazoxybenzene; p-Dodecyloxybenzoic Acid; p-Ethoxybenzylidene p-Butylaniline; p-Ethoxybenzylidene p-Cyanoaniline; p-Ethoxybenzylidene p-Heptylaniline; Ethyl 4-(4-pentyloxybenzylideneamino)benzoate; p-Heptyloxybenzylidene p-Butylaniline; 4-Heptyloxybenzylidene 4-heptylaniline; p-Hexadecyloxybenzoic Acid; p-Hexyloxybenzalazine; p-Hexyloxybenzoic Acid; 4-(4-Hexyloxybenzoyloxy)benzoic acid; p-Hexyloxybenzylidene p-Aminobenzonitrile; p-Hexyloxybenzylidene p-Butylaniline; p-Hexyloxybenzylidene p-Octylaniline; p-Methoxybenzylidene p-Biphenylamine; p-Methoxybenzylidene p-Butylaniline; p-Methoxybenzylidene p-Cyanoaniline; p-Methoxybenzylidene p-Decylaniline; p-Methoxybenzylidene p-Ethylaniline; p-Methoxybenzylidene p-Phenylazoaniline; 4-Methoxyphenyl 4′-(3-Butenyloxy)benzoate; p-Methylbenzylidene p-Butylaniline; p-Nitrophenyl p-Decyloxybenzoate; p-Nonyloxybenzoic Acid; p-Nonyloxybenzylidene p-Butylaniline; p-Octyloxybenzoic Acid; p-Octyloxybenzylidene p-Cyanoaniline; p-Pentyl benzoic Acid; p-Pentyloxybenzoic Acid; p-Pentyloxybenzylidene p-Heptylaniline; 4-Pentylphenyl 4′-propylbenzoate; p-Propoxybenzoic Acid; Terephthalylidene Bis(p-butylaniline); Terephthalylidene Bis(p-nonylaniline); p-Undecyloxybenzoic Acid and/or 4-pentyl-4′-cyano biphenyl. Commercially available liquid crystal substances include, but are not limited to, those from Merck (KGaA, Darmstadt Germany) under the trade designator Licristal® E44 (E44); Licristal® E7 (E7); Licristal® E63 (E63); Licristal® BL006 (BL006); Licristal® BL048 (BL048); Licristal® ZLI-4853 (ZLI-4853) and Licristal® MLC-6041 (MLC-6041). Other commercially available liquid crystal substances are also possible.

For the various embodiments, useful liquid crystal substances can also include those with a negative dielectric anisotropy. As used herein, “negative dielectric anisotropy” includes a state in which a dielectric coefficient parallel to a director is less than a dielectric coefficient perpendicular to the director, where the director refers to the local symmetry axis around which the long range order of the liquid crystal substance is aligned. Examples of liquid crystal substances having a negative dielectric anisotropy can include, but are not limited to, those found in U.S. Pat. No. 4,173,545 (e.g., p-alkyl-phenol-4′-hydroxybenzoate-4-alkyl(alkoxy)-3-nitrobenzoate), those having positive or negative dielectric anisotropies or that can switch from positive to negative as in the case of 4-cyano-4′-hexylbiphenyl and salicylaldimine (see: Physica B: Condensed Matter, Vol. 393, (1-2), pp 270-274), those discussed in “Advanced Liquid Crystal Materials with Negative Dielectric Anisotropy for Monitor and TV Applications” by Klasen-Memmer et al. (Proc Int Disp Workshops, vol. 9, pages 93-95, 2002), those found in “Nematic materials with negative dielectric anisotropy for display applications” by Hird et al. (Proc. SPIE Vol. 3955, p. 15-23, Liquid Crystal Materials, Devices, and Flat Panel Displays, March 2000), and those found in “Stable Liquid Crystals with Large Negative Dielectric Anisotropy” by Osman et al., (Helvetica Chimica Acta, Vol. 66, Issue 6, pp 1786-1789). The liquid crystal substances used for the phase compensation film can also function to prevent transmittance of at least a portion of radiant energy (e.g., light) in at least one of an infrared, a visible, and an ultraviolet frequency range through the small scale functional material.

For the various embodiments, the functional properties of the liquid crystal substance are not significantly affected once imbibed in the nano-domain structure. In addition, the nano-domain can also induce order to the liquid crystal substance imbibed substantially throughout the nano-domain. Ordered structure of similar characteristic length for the liquid crystal substance and the nano-domain are determined by x-ray scattering results, as provided in the Examples Section, below. These results suggest that an order can be induced by the cross-linked polymer domain. For example, when liquid crystal substances are imbibed substantially throughout the cross-linked polymer domain of the nano-domain, scattering studies discussed herein indicate a liquid crystal substance ordered structure with a characteristic length of 4 nm. This order induced by the nano-domains, however, is not observed in neat liquid crystal substance or in a solution of liquid crystal substance in polymethyl methacrylate.

For the various embodiments, a crosslink density of the cross-linked polymer domain of the small scale functional material can be increased after imbibing the liquid crystal substance into the cross-linked polymer domain of the nano-domains. For various embodiments, the post-imbibing cross-linking can be used to form non-spherical nano-domains. In addition, the liquid crystal substance can also be cross-linked to the polymer domain of the nano-domain once imbibed. Once formed the small scale functional materials can be prepared as a powder (e.g., lyophilized) for storage and subsequent use as discussed herein.

For the various embodiments, the small scale functional material used to form the phase compensation film can do so without causing haze or other issues that pertain to the clarity for the surface on which the phase compensation film is formed. As discussed, one reason for this may be that the nano-domain of the small scale functional material has a largest dimension of a quarter of a wavelength of visible light or less. By controlling the size of the nano-domain, the transparency of the resulting phase compensation film can be maintained for, by way of example, optical applications by eliminating domains of the size able to scatter light.

For the various embodiments, a dispersion of the small scale functional materials in the aqueous and/or non-aqueous liquid medium can be uniform. For the various embodiments, the dispersion of the small scale functional materials can also be dispersed spatially with varying concentration in one or more films (e.g., across a thickness of the phase compensation film) to create a gradient of refractive indexes. For example, two or more layers of the small scale functional material can be used where each layer has a different concentration to create a gradient of refractive indexes in the resulting film. For the various embodiments, the concentration gradients can be extended through a thickness of the film and/or across a width or length of the film.

For the various embodiments, the selection of the cross-linked polymer domain can be made based, in part, on the aqueous and/or non-aqueous liquid medium into which the small scale functional materials are suspended. For example, the cross-linked polymer can be selected so as to allow the small scale functional material to be dispersed within the aqueous and/or non-aqueous liquid medium. Approaches to dispersing the small scale functional materials throughout the aqueous and/or non-aqueous liquid medium can be carried out in mixing processes.

Embodiments of the present disclosure can be useful in a variety of applications. Such applications can include, but are not limited to, optical applications such as displays, ophthalmic lenses, fiber optics, Bragg reflectors, and wave guides, among others. The nano-domain of the small scale functional material can be made more rigid or softer by the selection of monomer that when co-polymerized produce domain formers with different material properties (e.g., Tg of the cross-linked polymer domain) and/or cross-linking density of the cross-linked polymer domain. For the various embodiments, the small scale functional materials can be dispersed in a concentration gradient spatially using a variety of printing technologies to create optical materials such as a gradient refractive index lenses.

A dichroic dye can also be imbibed in addition to one or more of the liquid crystal substance. Discotic liquid crystal substances, both columnar and the nematic, can also be imbibed. Examples of suitable dichroic dyes and/or additional liquid crystal substances include those found in U.S. Pat. Nos. 4,401,369 and 5,389,285; WO 1982/002209; arylazopyrimidines; Benzo-2,1,3-thiadiazoles (see: J. Mater. Chem., 2004, 14, 1901-1904); Merck Licristal®, and Merck Licrilite®, among others.

The present disclosure is illustrated by the following examples. It is to be understood that the particular examples, materials, amounts, and procedures are to be interpreted broadly in accordance with the scope and spirit of the disclosure as set forth herein. In addition, the complete disclosures of all patents, patent applications including provisional patent applications, publications, and electronically available material cited herein or in the documents incorporated herein by reference. The foregoing detailed description and examples have been provided for clarity of understanding only. No unnecessary limitations are to be understood therefrom. The embodiments of the disclosure are not limited to the exact details shown and described; many variations will be apparent to one skilled in the art and are intended to be included within the disclosure defined by the claims.

### EXAMPLES

Various aspects of the present disclosure are illustrated by the following examples. It is to be understood that the particular examples, materials, amounts, and procedures are to be interpreted broadly in accordance with the scope of the disclosure as set forth herein. Unless otherwise indicated, all parts and percentages are by weight and all molecular weights are number average molecular weight. Unless otherwise specified, all chemicals used are commercially available as indicated herein.

Reagents: methyl methacrylate (MMA, 99%, stabilized, Acros Organics); styrene (S, 99%, Aldrich), ethylene glycol dimethacrylate (EGDMA, 98%, stabilized, Acros Organics); divinylbenzene (DVB, 98%, Aldrich); sodium dodecyl sulfate salt (SDS, 98%, Acros Organics); 1-pentanol (99%, Acros Organics); methylene chloride (HPLC grade, Burdick and Jackson); acetone (HPLC grade, J. T. Baker); liquid crystal substances Licristal® (Merck, KGaA, Darmstadt Germany); poly (methyl methacrylate) of molecular weight 15,000 (Aldrich); butyl acrylate (BA, 99%, Stabilized, Aldrich); allyl methacrylate (AMA, Acros Organics, 98%); ammonium persulfate (APS, Acros Organics, 98+%); and N,N,N′,N′-tetramethylethylenediamine (TMEDA, Acros Organics, 99%).

All polymerizations are conducted in ultra-pure deionized water (UPDI water, passed through a Bamstead purifier, conductivity <10⁻¹⁷Ω⁻¹) under nitrogen.

### Preparation of Nano-Domains

For the present embodiments, MMA or BA, or S, or mixtures of these monomers are mixed with either AMA, or DVB, which serves as cross linking monomers, according to the amounts provided in Table 1. The mixture is filtered through a column partially packed with basic aluminum oxide (Acros Organics) to remove the stabilizing agents and charged into a 100 ml glass syringe. SDS and 1-pentanol, as provided in Table 1, are combined with the UPDI water and charged into the reactor where the mixture is stirred at low speed (200 rpm) and purged with nitrogen for 20 minutes at 30° C.

Equimolar amounts of APS and TMEDA are used as the two initiators. APS, as provided in Table 1, in 10 ml of UPDI water is used as a first initiator, and TMEDA, as provided in Table 1, in 10 ml of UPDI water is used as a second initiator for each of the Examples listed in Table 1.

An initial portion of the monomer mixture and the initiators, as provided in Table 1, are charged into a reactor to start the seed polymerization. Injection of the rest of the monomer via a syringe pump (KD Scientific) is started 30 minutes later at a rate as indicated in Table 1. The reactor 100 is purged with nitrogen and the temperature is held at 28° C. throughout the reaction. Polymerization continues for 1 hour. Once the monomer injection is completed, the resulting nano-domains are collected in a glass jar and a few drops of PennStop™ (Aldrich) are added into the jar to stop the polymerization reactions.

TABLE 1

| Component | Example 1 | | Example 2 | | Example 3 | | Example 4 | | Example 5 | |
|---|---|---|---|---|---|---|---|---|---|---|
| Monomer | 33.6 | g | 33.0 | g | 33.6 | g | 16.8 | g | 33.6 | g |
| MMA | | | | | | | | | | |
| Monomer | 0.6 | g | 1.2 | g | 1.2 | g | 0.6 | g | 0.6 | g |
| AMA | | | | | | | | | | |
| Monomer | 0 | g | 0 | g | 0 | g | 16.8 | g | 0 | g |
| BA | | | | | | | | | | |
| Monomer S | 0 | g | 0 | g | 33.6 | g | 0 | g | 0 | g |
| Surfactant | 0.75 | g | 0.675 | g | 6.08 | g | 3.04 | g | 3.04 | g |
| SDS | | | | | | | | | | |
| Surfactant | 0 | g | 0 | g | 2.16 | g | 1.08 | g | 1.08 | g |
| 1-Pentanol | | | | | | | | | | |
| UPDI Water | 255.4 | g | 255.4 | g | 510.8 | g | 255.4 | g | 255.4 | g |
| Initiator | 0.14 | g | 0.14 | g | 0.28 | g | 0.14 | g | 0.14 | g |
| APS | | | | | | | | | | |
| Initiator | 0.07 | g | 0.07 | g | 0.14 | g | 0.07 | g | 0.07 | g |
| TMEDA | | | | | | | | | | |
| Initial | 5.4 | ml at | 10.8 | ml at | 10.8 | ml at | 5.4 | ml at | 5.4 | g at |
| Amount | 200 | ml/hr | 200 | ml/hr | 200 | ml/hr | 200 | ml/hr | 200 | ml/hr |
| MMA/Other | | | | | | | | | | |
| Monomer | | | | | | | | | | |
| Monomer | 8.1 | ml/hr | 23.4 | ml/hr | 16.2 | ml/hr | 8.1 | ml/hr | 8.1 | ml/hr |
| Addition rate | | | | | | | | | | |
| MMA/Other | | | | | | | | | | |
| Monomer | | | | | | | | | | |

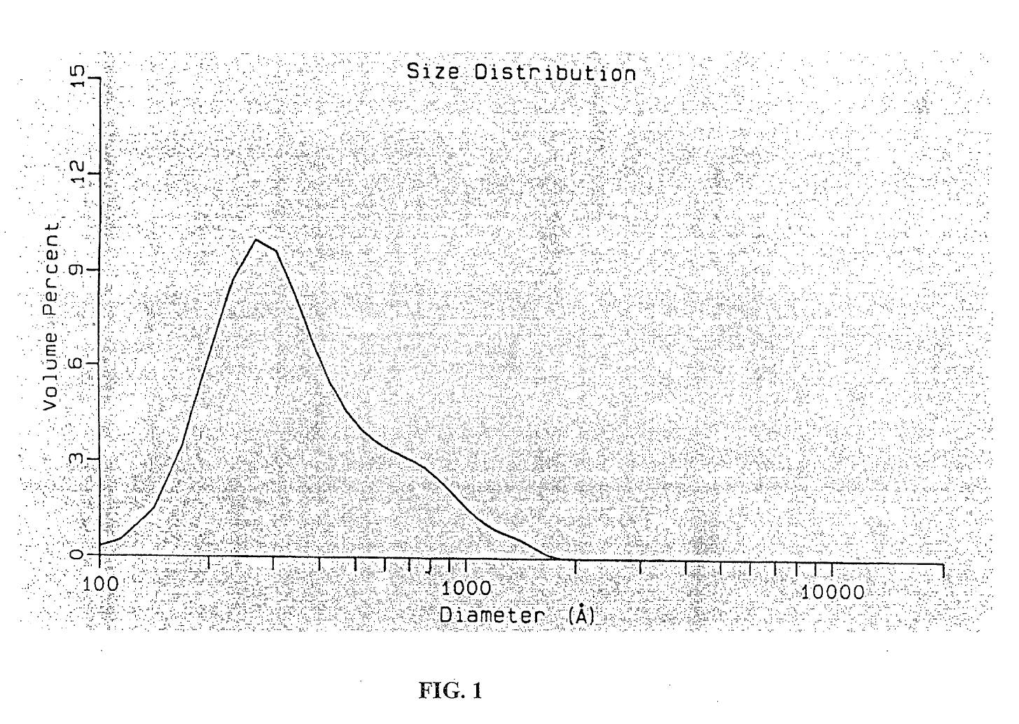

The volume mean diameter and particle size distribution of the nano-domains of Examples 1-5, as determined by hydrodynamic chromatography (described in “Development and application of an integrated, high-speed, computerized hydrodynamic chromatograph.” Journal of Colloid and Interface Science, Volume 89, Issue 1, September 1982, Pages 94-106; Gerald R. McGowan and Martin A. Langhorst) is shown in FIG. 1. Values for the volume mean diameter for the nano-domain can be from 10 nm to 100 nm. As for the particle size distribution, 70 percent of the nano-domains have a volume mean diameter smaller than 50 nm, where nano-domains having a volume average diameter of 30 nm were found.

The nano-domains are isolated according to one of three methods. In the first method, to a given volume of undiluted nano-domain suspension or latex, an equal volume of methyl ethyl ketone (MEK, Fisher, HPLC grade) is added. The resulting suspension is centrifuged at 2,000 rpm for 20 minutes (IEC Centra GP8R; 1500 G-force). The liquids are decanted and the nano-domains are resuspended in 1× the original volume of 1:1 UPDI water:acetone. The resuspended nano-domains are centrifuged and decanted two additional times. The nano-domains are dried for about 70 hours in a stream of dry air.

In a second method, to a given volume of the undiluted nano-domain suspension or latex, an equal volume of MEK is added. The resulting suspension is centrifuged as above. The liquids are decanted and the nano-domains are blended in UPDI water and added to acetone (equal volume). The nano-domain suspension is filtered and washed with several volumes of methanol (Fisher, HPLC grade) or 1:1 UPDI water:acetone. UPDI water, then methanol. The nano-domains are then dried for about 70 hours in a stream of dry air.

In a third method, to a given volume of the undiluted nano-domain suspension or latex, an equal volume of MEK is added. The resulting suspension is centrifuged as above. The liquids are decanted and the nano-domains are dissolved in a minimum amount of tetrahydrorfuran (THF, Fisher, HPLC grade). The nano-domains are precipitated by adding the THF solution slowly to a 5 to 10 fold excess of methanol. The precipitate nano-domains are filtered and washed with methanol (Fisher, HPLC grade), and then dried as described above.

### Liquid Crystal Substances

A variety of liquid crystal substances are used in the examples provided herein. A first example includes Licristal® E44 (Merck, KGaA, Darmstadt Germany), 4-pentyl-4′-cyano biphenyl, which is a nematic liquid crystal substance with clearing point (transition to isotropic fluid) at 100° C., a dielectric anisotropy (Ac) of +16.8, and optical anisotropy (An) of 0.2627. Other liquid crystal substances used in the present examples include 4-Cyano-4′-octylbiphenyl (Frinton Laboratories, NJ); Licristal® E7; Licristal® E63; Licristal® BL006; Licristal® BL048; Licristal® ZLI-4853 and Licristal® MLC-6041 (each from Merck, KGaA, Darmstadt Germany). In the various examples, the liquid crystal substances and/or mixtures of the liquid crystal substances are utilized to observe their influence on order in the nano-domain.

Table 2 displays some of the properties of the liquid crystal substances. The liquid crystal substances are selected at least in part for their high refractive index anisotropy.

TABLE 2

| Liquid crystal | Clearing Point | Optical |
|---|---|---|
| substance | (° C.) | Anisotropy, Δn |
| Licristal ® E44 | 100 | 0.2627 |
| Licristal ® E7 | 59-60 | 0.286 |
| Licristal ® E63 | 82 | 0.2272 |
| Licristal ® BL006 | 115 | 0.286 |
| Licristal ® ZLI-4853 | 71 | 0.1323 |
| Licristal ® MLC-6041 | 84 | 0.1584 |
| 4-Cyano-4′-octylbiphenyl | 40.5 | |

Imbibing Liquid Crystal Substances into Nano-Domains

A sample of the liquid crystal substance is dissolved in methylene chloride in a glass container, as provided in Table 3, to form a solution. Acetone is added to the solution, which is mixed until a clear solution to the eye is obtained. An aqueous dispersion of the nano-domains is weighed and added to the solution to form a mixture. The mixture is shaken at room temperature (about 21° C.) overnight.

Imbibing the liquid crystal substance into the nano-domains as described above is based on the transport of the liquid crystal molecules across the water-methylene chloride interface into the dispersed nano-domains. There are indications of this process in mixing the aqueous dispersion, with the solution. Upon mixing, the aqueous dispersion of nano-domains increases its light scattering power significantly. This suggests an increase in average particle size by either swelling of the nano-domains by the solution or agglomeration of particles. The aqueous dispersion of nano-domains remains stable substantially throughout the mixing, shaking, and decanting processes within the operational ranges; e.g., there is no precipitation of the nano-domains.

The mixture is allowed to phase separate for three hours at room temperature (about 21° C.). Two phases evolve in the container: a methylene chloride rich phase at the bottom of the container, and an aqueous phase on top. The aqueous phase is decanted and freeze-dried to obtain the nano-domains imbibed with liquid crystal substances. The resulting nano-domains imbibed with liquid crystal substances have the appearance of a fluffy white powder.

The liquid crystal substances provided in the examples are all successfully imbibed in the nano-domains of Examples 1-5 (above) utilizing the same procedure described above. Table 3 shows the liquid crystal amount in nano-domains of Example 1 imbibed with the various liquid substances. The amount of the liquid crystal substance in the nano-domains varies from about 6 percent to about 25 percent by weight of the small scale functional material. The lowest amount (6.2 percent by weight) corresponds to Licristal® ZLI-4853, followed by Licristal® MLC-6041 (11.6 percent by weight) and Licristal® BL048 (13.2 percent by weight). Licristal® E44 (24.6 percent by weight) and Licristal® E7 (23.1 percent by weight) are imbibed at the highest amount in Example 1 of the nano-domains. Similar results with slightly higher amounts are obtained with nano-domains of Example 1 of 60 nm volume mean diameter.

TABLE 3

| | | Nano- | | | | | |
|---|---|---|---|---|---|---|---|
| | | Domain | | | | | Liquid |
| | Liquid | volume | Liquid | | | Nano- | Crystal |
| | Crystal | mean | Crystal | | | Domain | Substance |
| | Substance | diameter | Substance | MeCl₂ | Acetone | Emulsion | Amount |
| Example | (Licristal ®) | (nm) | wt (g) | wt (g) | (g) | wt (g) | (wt. %) |
| 6 | E7 | 30 | 0.592 | 1.370 | 1.167 | 5.048 | 23.1 |
| 7 | E63 | 30 | 0.565 | 1.341 | 1.146 | 5.004 | 17.2 |
| 8 | MLC- | 30 | 0.586 | 1.345 | 1.163 | 5.035 | 11.6 |
| | 6041 | | | | | | |
| 9 | BL006 | 30 | 0.585 | 1.349 | 1.152 | 5.023 | 20.4 |
| 10 | ZLI-4853 | 30 | 0.578 | 1.355 | 1.166 | 5.010 | 6.2 |
| 11 | BL048 | 30 | 0.566 | 1.354 | 1.147 | 5.037 | 13.2 |
| 12 | E44 | 30 | 5.780 | 13.410 | 11.500 | 50.280 | 24.6 |
| 13 | E7 | 60 | 1.158 | 2.745 | 2.295 | 10.043 | 26.1 |
| 14 | E63 | 60 | 1.165 | 2.714 | 2.306 | 10.005 | 19.7 |
| 15 | BL006 | 60 | 1.153 | 2.701 | 2.327 | 9.999 | 28.4 |
| 16 | BL048 | 60 | 1.153 | 2.742 | 2.302 | 9.999 | 22.6 |
| 17 | MLC- | 60 | 1.154 | 2.697 | 2.435 | 10.011 | 10.1 |
| | 6041 | | | | | | |
| 18 | ZLI-4853 | 60 | 1.161 | 2.696 | 2.310 | 10.016 | 9.7 |

### FTIR Spectroscopy

FTIR spectroscopy (Nicolet 710 FTIR) is utilized to determine the presence and quantity of liquid crystal substance imbibed in the nano-domains of Example 1.

For calibration of the FTIR, 0.887 g of poly(methyl methacrylate) is dissolved in 16.78 g of methylene chloride. The mixture is agitated until a clear solution homogeneous to the eye is obtained. To this solution, the necessary amount of liquid crystal substance is added and agitated until the mixture is clear to the eye. The solution is poured onto a release surface (e.g., a sheet) of poly(tetrafluoroethylene), and placed in a vacuum oven operating at room temperature (about 21° C.) to evaporate the methylene chloride. The films obtained are used to calibrate the FTIR measurements.

The small scale functional materials produced are characterized with FTIR and x-ray scattering. FTIR spectroscopy is used to determine the amount of liquid crystal substance in the nano-domains.

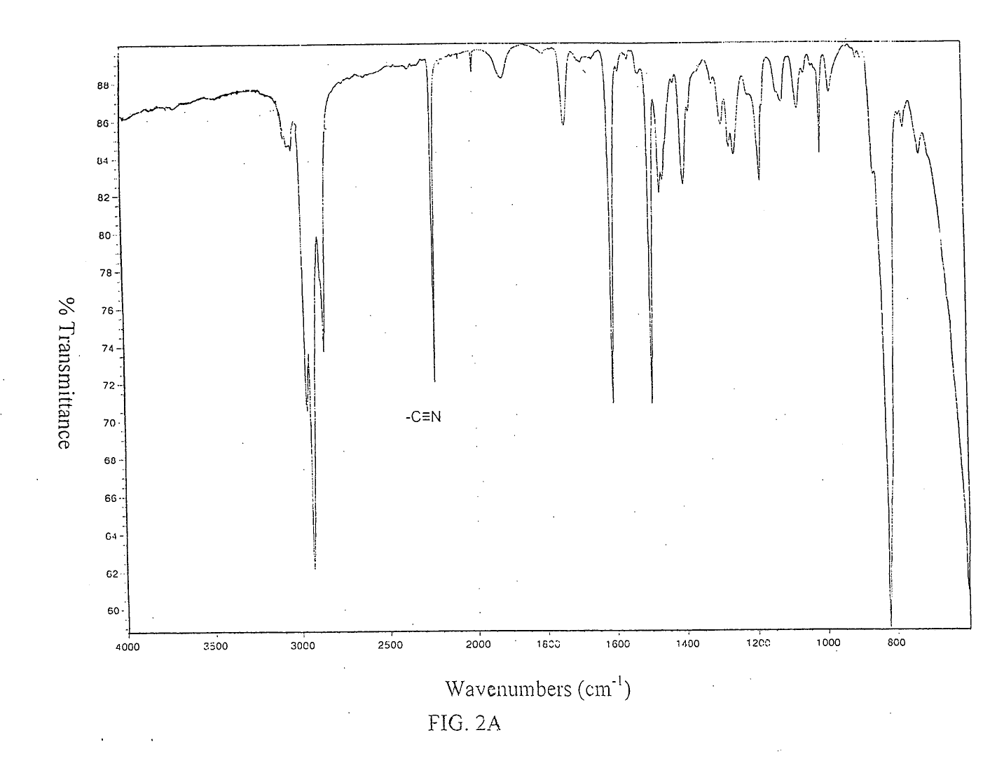

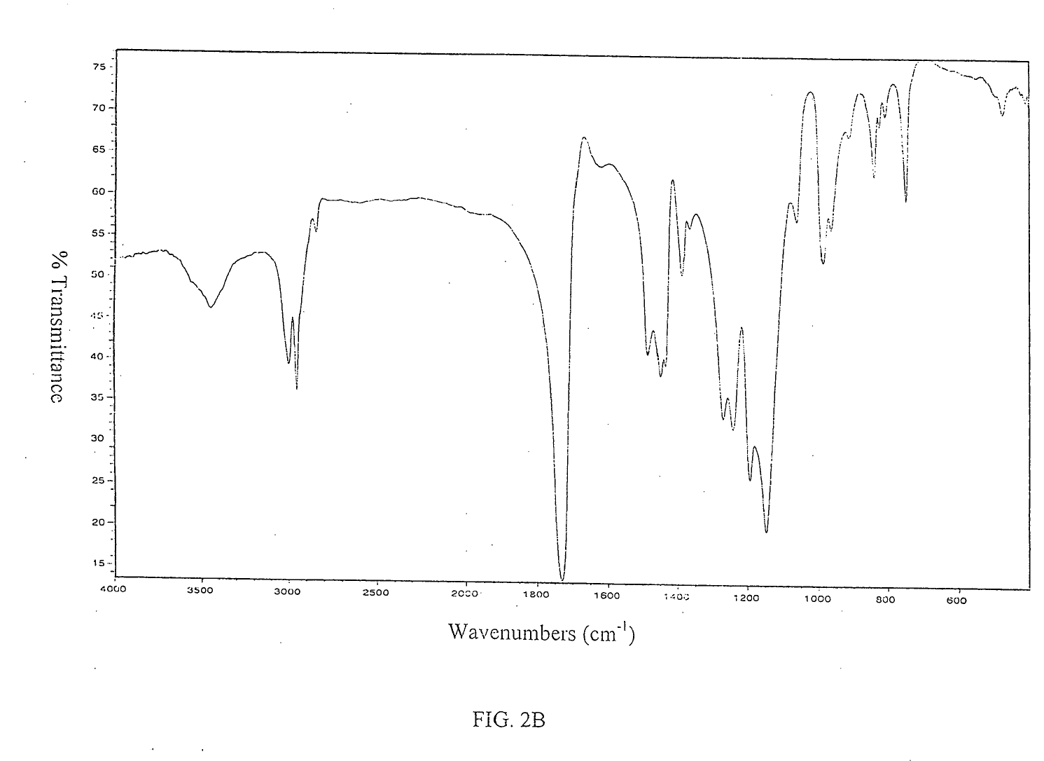

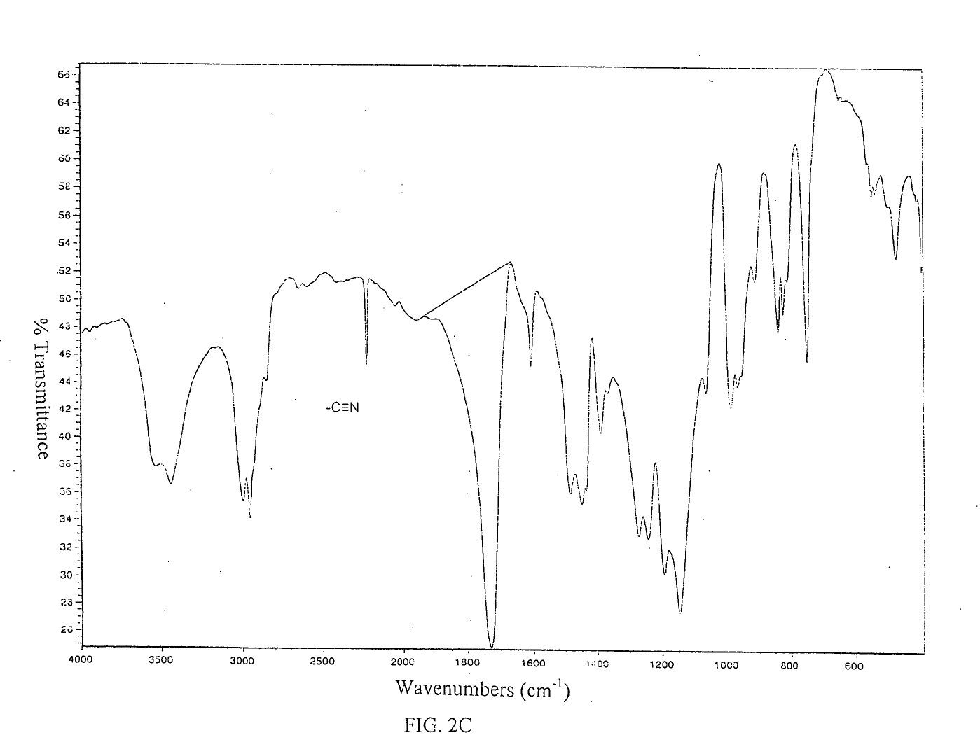

Typical spectra for Licristal® E44, nano-domains of Example 1, and nano-domains of Example 1 imbibed with Licristal® E44 are shown in FIGS. 2A-2C. The FTIR spectrum of Licristal® E44 is characterized by the aromatic C≡N line at about 2230 cm⁻¹ (FIG. 2A). FIG. 2B illustrates the spectra for the nano-domains of Example 1. The spectrum of nano-domains containing Licristal® E44 shows the C≡N band at about 2230 cm⁻¹, which confirms the presence of liquid crystal substances in the nano-domain (FIG. 2C).

The ratio of the C≡N line of the liquid crystal substance to the C═O line (at about 1730 cm⁻¹) of the nano-domain is utilized to determine the liquid crystal substance amount in the nano-domain. Liquid crystal/nano-domain standard compositions of known amounts are prepared for calibration. Since all other liquid crystal substances present the aromatic C≡N line, the same method is utilized to characterize the liquid crystal substance amount in the nano-domain particles. Standard compositions are prepared for each liquid crystal substance and nano-domain composition for calibration.

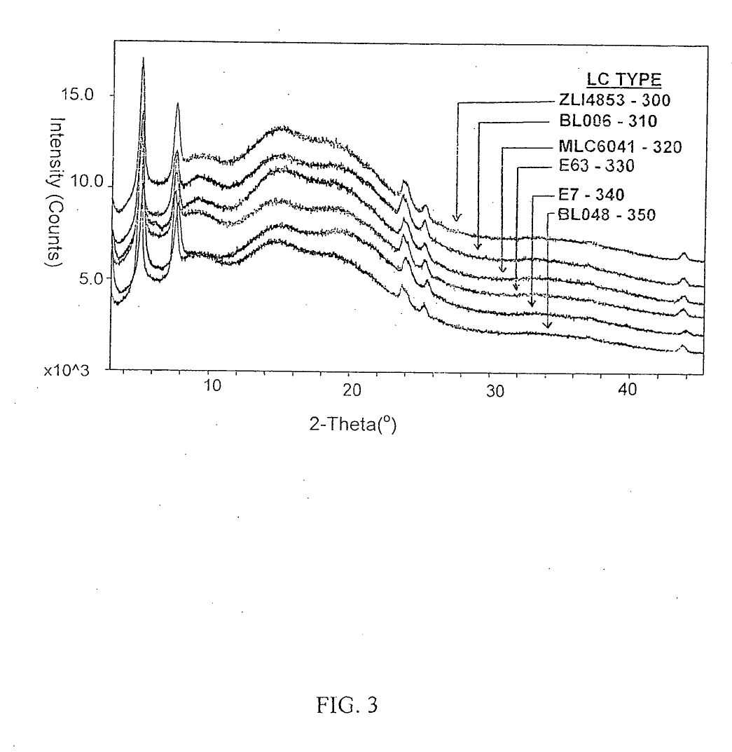

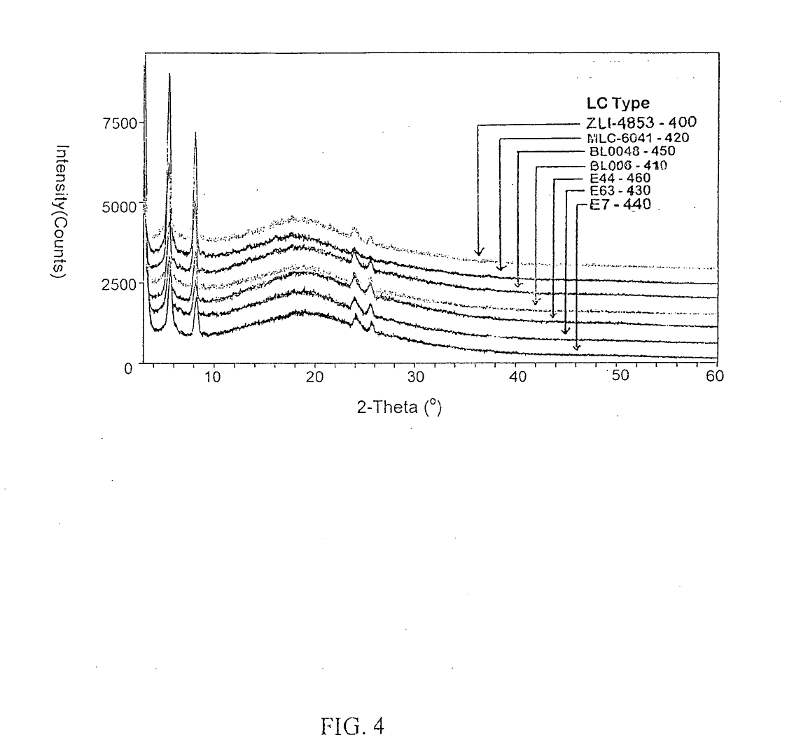

FIG. 3 presents x-ray scattering patterns of the nano-domains of Example 1 that are imbibed with the liquid crystal substances of the examples. In FIG. 3, x-ray scattering pattern 300 is for Licristal® ZLI-4853, x-ray scattering pattern 310 is for Licristal® BL006, x-ray scattering pattern 320 is for Licristal® MLC-6041, x-ray scattering pattern 330 is for Licristal® E63, x-ray scattering pattern 340 is for Licristal® E7, and x-ray scattering pattern 350 is for Licristal® BL048. As illustrated, the x-ray scattering patterns are similar for each of the liquid crystal substances. The scattering bands appear to be located at the same 20 angle for the liquid crystal substances, with only Licristal® E7 (340) showing a very small shift to higher angle (smaller size feature). The scattering peaks correspond to a liquid crystal ordered structure with a characteristic length of 4 nm. This order induced by the nano-domain is not observed in neat liquid crystal substances or in a solution of liquid crystal substances in PMMA. This may suggest that the length scale is determined by the composition and structure of the nano-domain. However, as discussed herein, the nano-domain composition (e.g., copolymers) does not appear to have a significant impact on the characteristic length for the compositions of the examples. For example, FIG. 4 illustrates that similar results are observed in the nano-domains of Example 3 (MMA/S1:1) imbibed with the various liquid crystalline materials. In FIG. 4, x-ray scattering pattern 400 is for Licristal® ZLI-4853, x-ray scattering pattern 410 is for Licristal® BL006, x-ray scattering pattern 420 is for Licristal® MLC-6041, x-ray scattering pattern 430 is for Licristal® E63, x-ray scattering pattern 440 is for Licristal® E7, x-ray scattering pattern 450 is for Licristal® BL048, and x-ray scattering pattern 440 is for Licristal® E44.

It is additionally observed that an increase in light scattering during the preparation of the imbibed nano-domains is dependent upon the amount of acetone in the liquid crystal substance used in imbibing nano-domains. This suggests an influence of acetone content on the liquid crystal substance being imbibed into the nano-domains. To test the influence of acetone content on the liquid crystal substance being imbibed into the nano-domains, a study of the factors affecting the imbibing process is performed in which a 3×6 factorial design experiment with one center point is used. An amount of liquid crystal substance in the imbibing solution and acetone to liquid crystal substance weight ratio are used as the variables in the study. Preparation temperature and shaking conditions are kept constant during the study.

Table 4 provides the design, variable levels, and liquid crystal substance amount after freeze-drying as determined by FTIR. The maximal amount of liquid crystal substance in the imbibing solution is 30 percent by weight. The maximal acetone to liquid crystal weight ratio is 2.0. This value is limited by the stability of the aqueous dispersion of nano-domains. A higher amount of acetone initiates the agglomeration and precipitation of the particles out of the dispersion. The maximal Licristal® amount imbibed in the dry nano-domains is 20 percent by weight in these experiments.

TABLE 4

| | Licristal ® | Acetone/ | Liquid | Weight of | | |
|---|---|---|---|---|---|---|
| | E44 | Licristal ® | Crystal | Licristal ® | Capsule | |
| | Amount | E44 | Substance | E44 | suspension | |
| Factorial | in MeCl₂ | weight | Amount | solution | (11.5% by | Acetone |
| Pattern | (wt. %) | ratio | (wt. %) | (g) | wt.) (g) | (g) |
| 3 × 5 | 30 | 1.8 | 18 | 1.92 | 5 | 1.04 |
| 3 × 4 | 30 | 1.6 | 17.7 | 1.92 | 5 | 0.92 |
| 3 × 3 | 30 | 1.21 | 14.1 | 1.92 | 5 | 0.7 |
| 2 × 5 | 20 | 1.8 | 11.6 | 2.875 | 5 | 1.04 |
| 3 × 2 | 30 | 0.87 | 12.5 | 1.92 | 5 | 0.5 |
| 3 × 1 | 30 | 0.34 | 11.3 | 1.92 | 5 | 0.2 |
| 1 × 4 | 11.5 | 1.6 | 6.1 | 5 | 5 | 0.92 |
| 2 × 2 | 20 | 0.87 | 9.1 | 2.875 | 5 | 0.5 |
| 1 × 2 | 11.5 | 0.87 | 5.6 | 5 | 5 | 0.5 |
| 2 × 4 | 20 | 1.6 | 11.1 | 2.875 | 5 | 0.92 |
| 1 × 3 | 11.5 | 1.21 | 5.7 | 5 | 5 | 0.7 |
| 2 × 6 | 20 | 2 | 12.5 | 2.875 | 5 | 1.15 |
| 3 × 6 | 30 | 2 | 20.7 | 1.92 | 5 | 1.15 |
| 1 × 6 | 11.5 | 2 | 7.6 | 5 | 5 | 1.15 |
| 1 × 1 | 11.5 | 0.34 | 3.8 | 5 | 5 | 0.2 |
| 1 × 5 | 11.5 | 1.8 | 5.2 | 5 | 5 | 1.04 |
| 2 × 3 | 20 | 1.21 | 10.5 | 2.875 | 5 | 0.7 |
| 2 × 1 | 20 | 0.34 | 7.9 | 2.875 | 5 | 0.2 |
| 0 × 0 | 15.75 | 0.605 | 6.2 | 3.65 | 5 | 0.35 |

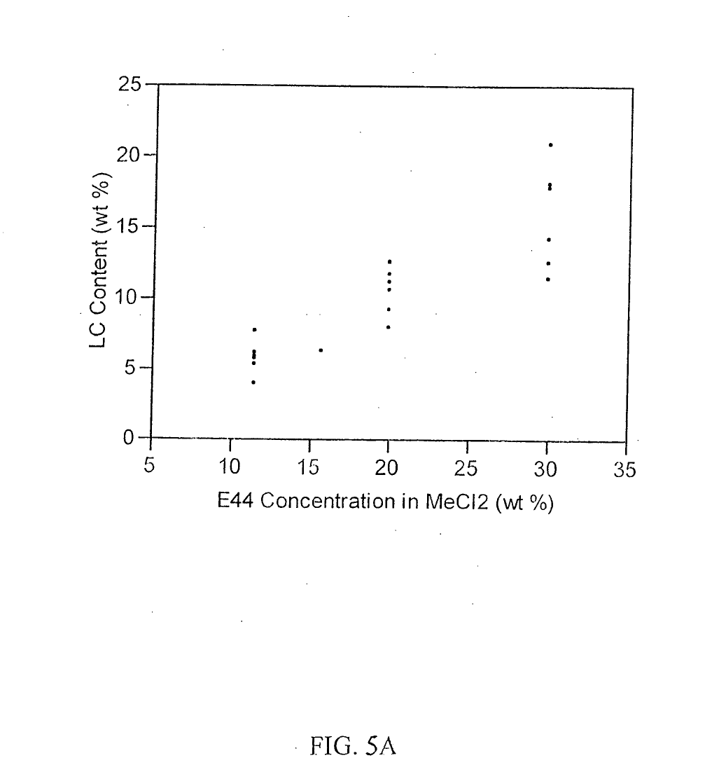

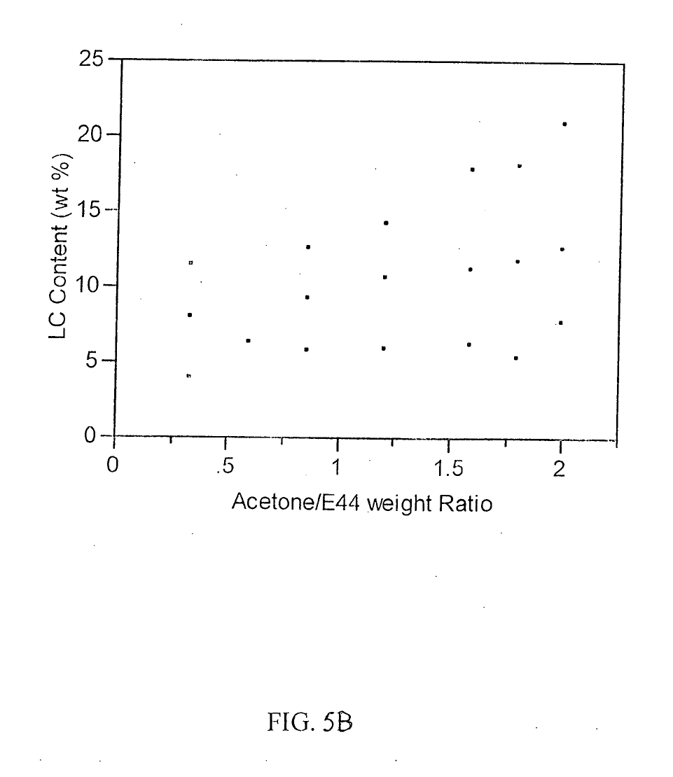

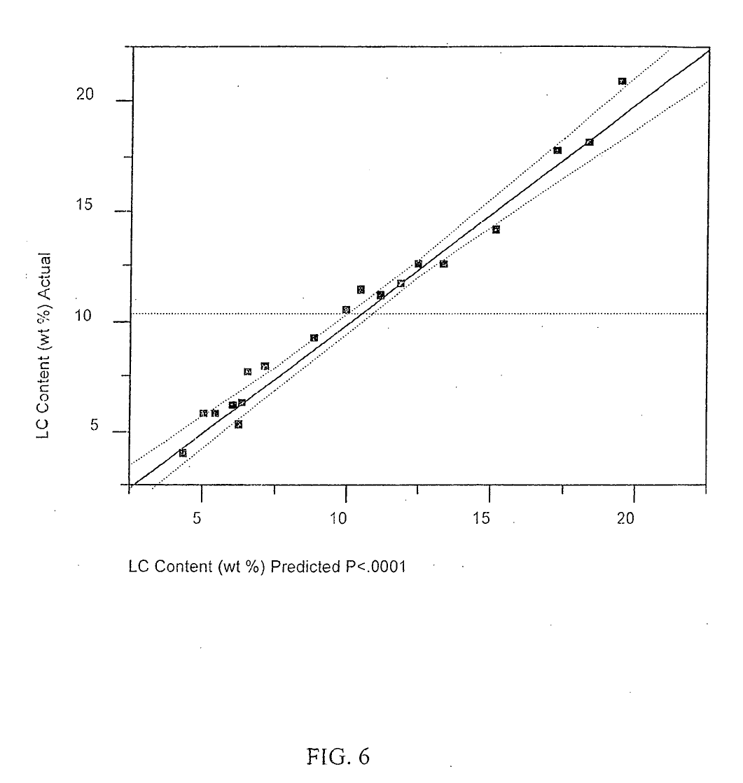

FIGS. 5A and 5B show the amount of liquid crystal substance imbibed in the nano-domain of Example 1 as a function of the concentration of Licristal® E44 in the methylene chloride precursor solution for various acetone/Licristal® E44 weight ratios (FIG. 5A), and acetone to Licristal® E44 weight ratio in the precursor solution for various concentrations of Licristal® E44 in the precursor solution (FIG. 5B). Both curves indicate a direct correlation between the liquid crystal substance amount in the dry nano-domain and both variables. The amount of liquid crystal substance in the dry nano-domain increases directly with the concentration of liquid crystal substance in the imbibing solution and the acetone to liquid crystal substance weight ratio. In addition, there is an inter-relationship between the two variables discussed above. The results of a least square fit model of the amount of liquid crystal substance in the dry nano-domain are shown in FIG. 6. A statistically significant fit of the data (R²=0.9799) is obtained when the two variables and a cross term are utilized (as shown by the analysis of variance P<0.0001 for the three terms). According to this fit, the amount of liquid crystal in the dry nano-domains can be expressed as follows:

% LC=−4.657+0.536 LCS %+3.278 AC/LC Ratio+0.22(LCS %×AC/LC ratio)

where % LC is the amount of liquid crystal substance in the dry nano-domains; LCS % is the concentration of liquid crystal substance in the imbibing solution; AC/LC Ratio is the weight ratio of acetone to liquid crystal substance in the imbibing solution; and (LCS %×AC/LC Ratio) is the cross term. The fitted model also incorporates a non-zero intercept. This fit appears to explain about 98 percent of the variation in liquid crystal substance amount in the nano-domain caused by the concentration of liquid crystal substance and acetone to liquid crystal substance weight ratio in the imbibing solution.

Licristal® E44 is sold as a nematic liquid crystal substance. The liquid crystal maintains its orientational order up to the clearing point at which the liquid crystal becomes an isotropic fluid (100° C.). Imbibing of the liquid crystal substances into nano-domains may impact the morphology of the liquid crystal and/or the nano-domains. X-ray scattering techniques are utilized to probe the morphology of the liquid crystal substance imbibed nano-domains.

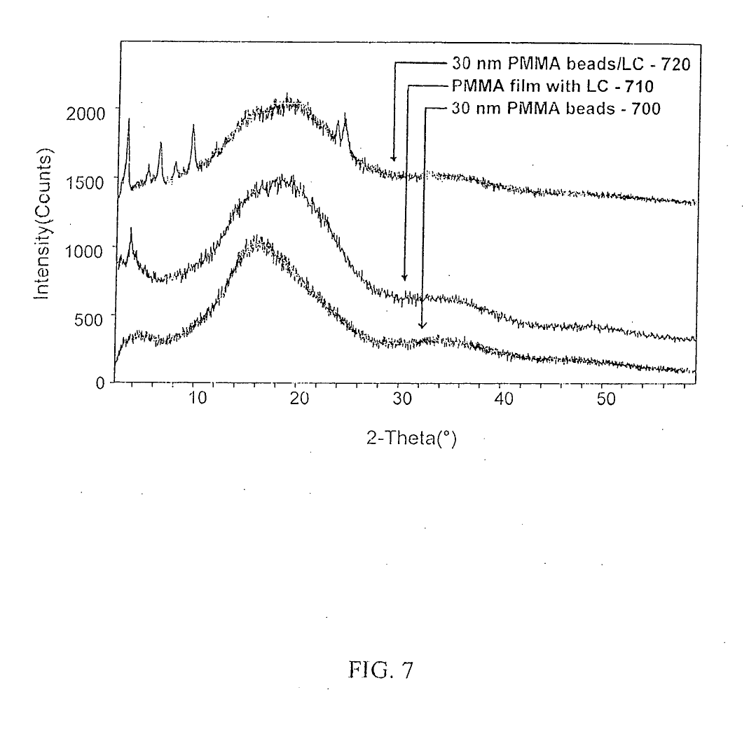

The x-ray scattering patterns of selected materials are presented in FIG. 7. The scattering pattern corresponding to the nano-domains of Example 1, without liquid crystal substances, is represented by curve 700. This curve shows a broad halo of an amorphous polymeric material without a specific structural arrangement. Curve 710 corresponds to a solution of Licristal® E44 in PMMA polymer. This curve presents a very similar amorphous pattern with a small peak at higher angle indicative of a crystalline or smectic liquid crystal phase. In contrast, curve 720 corresponds to the nano-domains of Example 1 imbibed with Licristal® E44 having several diffraction peaks indicating the presence of smectic or crystalline order with the leading peak representative of a 40 Å feature. This feature length is consistent with bilayer d-spacing in Licristal® E44.

### Process Temperature

The effect of temperature on the imbibing process is tested for Licristal® E44 imbibed in nano-domains of Example 1. Temperatures between ambient (21° C.) and 50° C. are analyzed. The highest temperature is selected to prevent instability of the nano-domain/imbibing solution bi-phasic system and avoid precipitation of the nano-domains in the imbibing process.

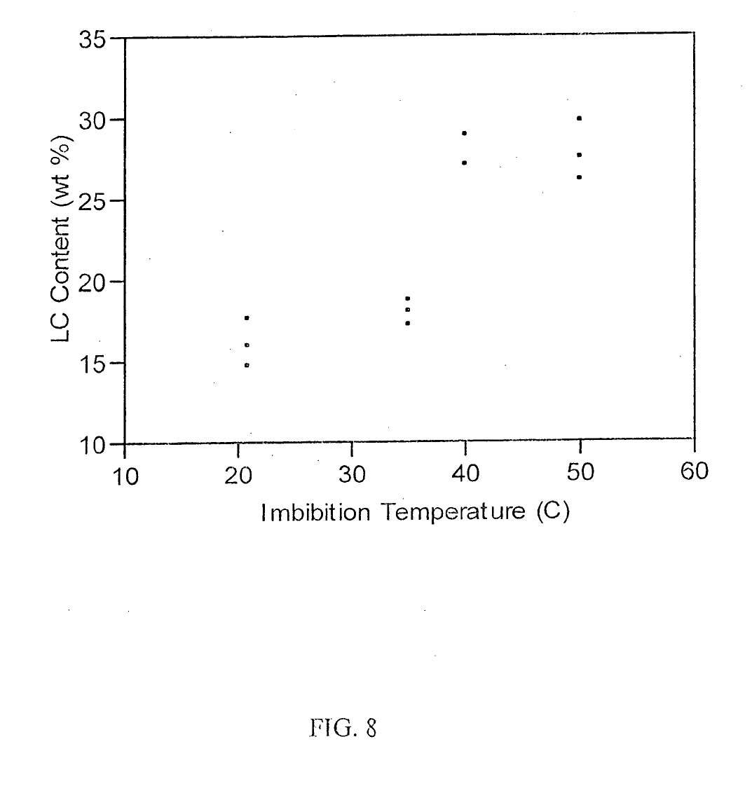

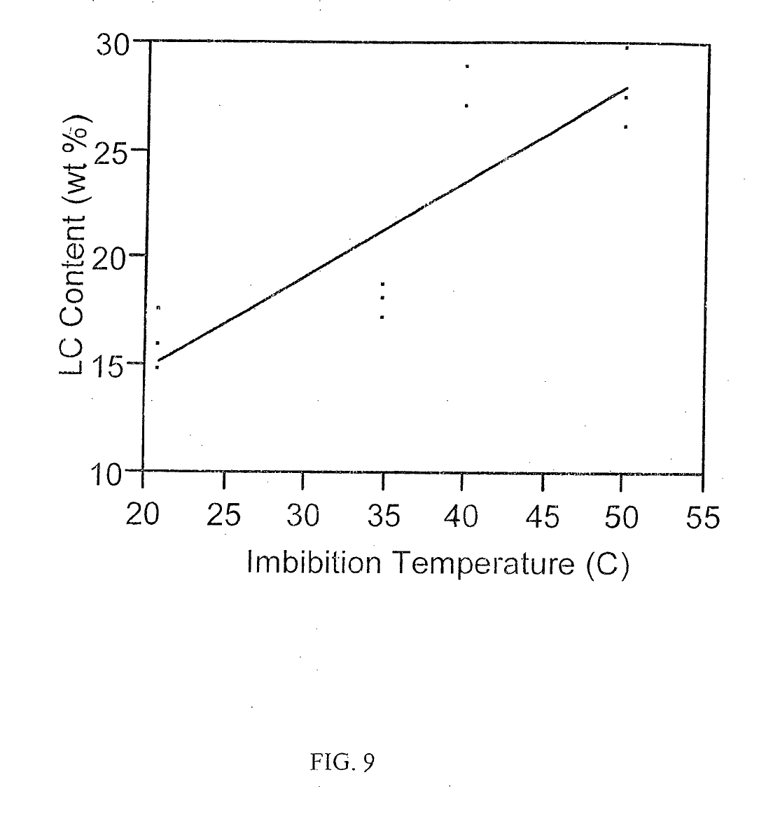

Table 5 and FIG. 8 present the liquid crystal substance amount in the nano-domains as a function of the imbibing temperature. The data suggests that the higher imbibing temperatures promote higher liquid crystal substance amounts in the nano-domains. FIG. 9 illustrates the results of a least squares fit model of the amount of Licristal® E44 imbibed in the nano-domains of Example 1 as a function of temperature. A statistically significant fit of the data is obtained (with R²=0.7396, and analysis of variance P<0.0007) that indicates that about 75 percent of the variation in the amount of liquid crystal substance in the nano-domains is attributable to the effect of temperature. The analysis provides a temperature coefficient of 0.44 for the amount of Licristal® E44 in the nano-domains of Example 1.

TABLE 5

| Temperature (° C.) | Liquid Crystal Amount (wt. %) |
|---|---|
| 21 | 15.9 |
| 21 | 17.5 |
| 21 | 14.7 |
| 35 | 17.2 |
| 35 | 18.0 |
| 35 | 18.7 |
| 40 | 28.8 |
| 40 | 27.0 |
| 50 | 27.4 |
| 50 | 26.1 |
| 50 | 29.7 |

### Nano-Domain Size

X-ray scattering data indicates that the nano-domains of Example 1 imbibed with Licristal® E44 have several diffraction peaks indicating the presence of smectic or crystalline order with the leading peak representative of a 40 Å feature. This feature length is consistent with bilayer d-spacing in Licristal® E44. Based on these findings, nano-domains of larger size are made to better understand whether the composite morphology of the nano-domain is affected. Table 6 presents the composition of nano-domains of Example 1 have a volume mean diameter of 30 nm and 60 nm which are imbibed with a variety of liquid crystal substances. The results indicate that the amount of liquid crystal substance imbibed in the nano-domains is slightly higher for larger nano-domains. For example, 30 nm nano-domains imbibed with Licristal® E7 present 23.1 wt. percent of liquid crystal substance. Sixty nanometer nano-domains imbibed with the same liquid crystal substance contain 26.1 wt. percent. Other liquid crystal substances show a similar increase in amount as the volume mean diameter of the nano-domain increases from 30 nm to 60 nm. This change in the liquid crystal substance amount, however, is not believed to be significant enough to suggest that the nano-domains/liquid crystal morphology is one of core-shell nature.

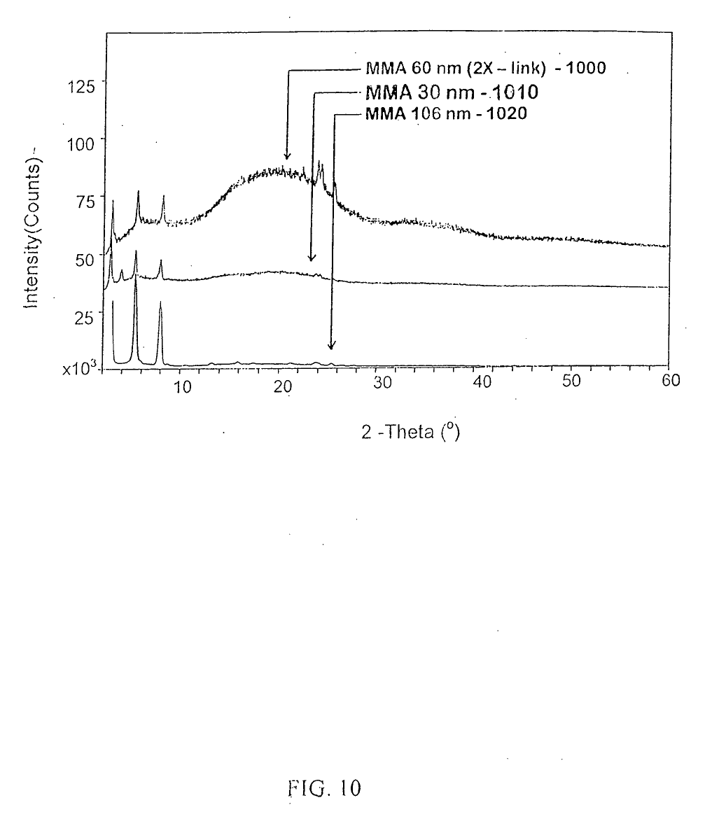

The x-ray scattering patterns of nano-domains of Example 1 of 30 nm (1010 in FIG. 10) and 106 nm (1020 in FIG. 10) both imbibed with Licristal® E44 are shown in FIG. 10. The main scattering features are similar for both compositions and are indicative of similar ordered structures. The main peaks are consistent with a characteristic length of 4 nm in both cases. FIG. 10 also presents the scattering pattern for 60 nm nano-domains (1000 in FIG. 10) whose cross-link density is increased by utilizing twice the concentration of AMA in the micro-emulsion polymerization. This pattern has similar features to all others with the same associated characteristic length (4 nm). The liquid crystal substance amount (Licristal® E44) in these nano-domains is 23.2 wt. percent (Table 6) which is similar to that of 30 nm nano-domains (24.6 wt. percent) with half the level of cross-linking agent. This suggests that the higher level of cross-linking agent in these nano-domains does not prohibit imbibing the liquid crystal substance with the process and conditions utilized for these examples.

TABLE 6

| | | | Nano- | | | | | |
|---|---|---|---|---|---|---|---|---|
| | | | Domain | | | | | Liquid |
| | | | volume | Liquid | | | Nano- | Crystal |
| | | Nano- | mean | Crystal | | Acetone | Domain | Substance |
| | Liquid Crystal | Domain | diameter | Substance | MeCl₂ | wt. | Emulsion | Amount |
| Example | Substance | Composition | (nm) | wt. (g) | wt. (g) | (g) | wt. (g) | (wt. %) |
| 19 | E44 | Example 1 | 30 | 5.780 | 13.410 | 11.500 | 50.280 | 24.6 |
| 20 | E44 | Example 1 | 106 | 1.818 | 2.870 | 1.389 | 10.070 | — |
| 21 | E44 | Example 2 | 60 | 5.750 | 13.520 | 11.560 | 50.040 | 23.2 |
| 22 | E44 | Example 3 | 30 | 1.173 | 2.707 | 2.310 | 10.053 | 17.8 |
| 23 | E44 | Example 4 | 40 | 1.951 | 2.836 | 2.876 | 12.520 | 24.4 |
| 24 | E7 | Example 3 | 30 | 1.153 | 2.700 | 2.337 | 10.010 | 6.4 |
| 25 | E63 | Example 3 | 30 | 1.169 | 2.704 | 2.308 | 10.044 | 15.7 |
| 26 | BL006 | Example 3 | 30 | 1.177 | 2.706 | 2.308 | 10.098 | 18.0 |
| 27 | BL048 | Example 1 | 30 | 1.167 | 2.698 | 2.306 | 10.020 | 11.3 |
| 28 | MLC-6041 | Example 3 | 30 | 1.161 | 2.715 | 2.304 | 10.032 | 12.8 |
| 29 | ZLI-6041 | Example 3 | 30 | 1.164 | 2.714 | 2.300 | 10.045 | 12.9 |
| 30 | 4-Cyano-4′- | Example 1 | 30 | 1.167 | 2.698 | 2.306 | 10.020 | 11.8 |
| | octylbiphenyl | | | | | | | |
| 31 | 4-Cyano-4′- | Example 3 | 30 | 1.173 | 2.707 | 2.310 | 10.053 | 16.6 |
| | octylbiphenyl | | | | | | | |

### Nano-Domain Composition

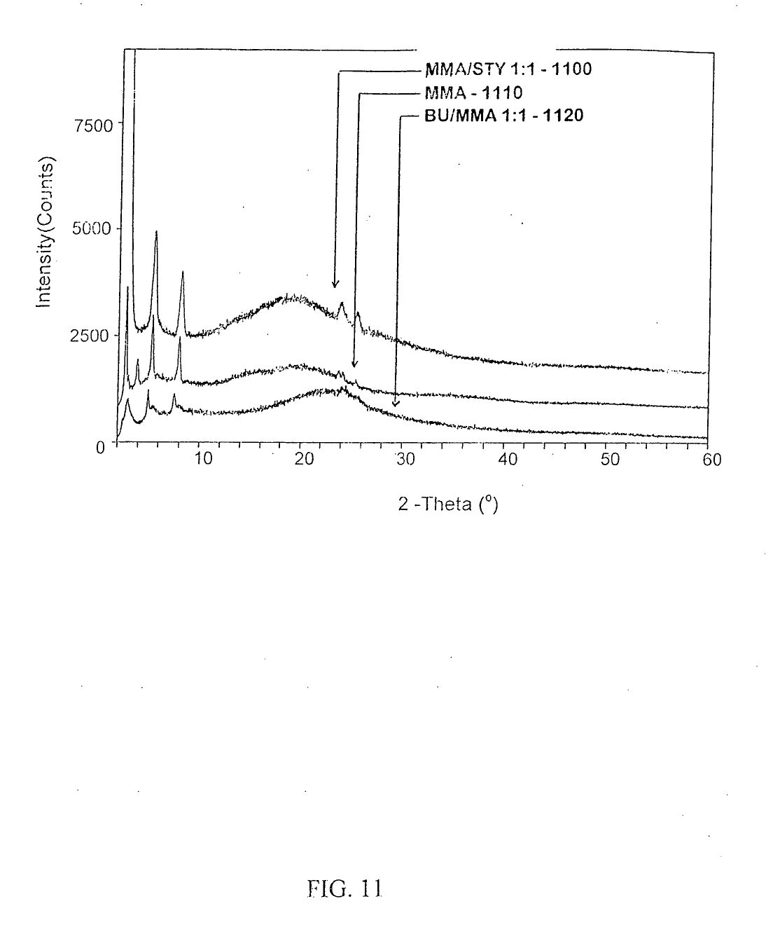

FIG. 11 shows x-ray scattering patterns of nano-domains of various compositions imbibed with Licristal® E44. The three compositions are Examples 1 (1110 in FIG. 11), 3 (1100 in FIG. 11), and 4 (1120 in FIG. 11) from Table 1. The three nano-domains compositions have a volume mean diameter of about 30 nm to about 40 nm. These patterns shown at 1100, 1110 and 1120 indicate ordered structures in all compositions. The main scattering features are similar for all compositions and are located at the same angles. The main peaks are consistent with a characteristic length of 4 nm. Nevertheless, there are small differences in the patterns. For example, the nano-domain of Example 1 presents a small peak at 2θ=2.5 that does not appear in the nano-domains of Examples 3 and 4.

### Film Forming Characteristics of the Small Scale Functional Material

A film forming solution for each of three different small scale functional materials (Examples 19, 27, and 30, above) are prepared as discussed herein. Each film forming solution is formed with 0.2 grams of the small scale functional material (Examples 19, 27, and 30 in powder form) suspended in 90 grams of toluene (Aldrich, HPLC grade), 9.4 grams of dibutyl maleate (Aldrich, 99.9%), and 0.2 grams of BYK-320 (a silicone leveling agent, BYK Chemie) at 20° C. for 20 minutes. Surprisingly, it is discovered that there is a sudden drop in haze percentage measurements for films formed with film forming solutions having about 9 to about 10 percent by weight dibutyl maleate with the toluene.

Films for each of the three small scale functional materials are formed by a draw coating process. For the process, a 200 μL sample of the film forming solution is deposited on a glass slide, across which a draw bar of height equal to 0.020 in. is drawn at 3.8 inches/sec using an automatic draw machine (Gardco, DP-8201). The samples are allowed to fully dry and have a thickness of about 35 μm.

Each of the films formed with the above film forming solutions have a total haze of between less than about 2 percent haze (measured as discussed below), and a total transmittance of 90 percent or greater (measured as discussed below) while on the glass substrate. With these low haze and high transmittance results, the behavior of the small scale functional materials as film formers with high-quality optics (low haze and high transmittance) may enable the use of such materials for optical applications such as phase retardation films, lenses, gradings, anti-reflective coatings, and privacy coatings, among other applications.

### Optical Performance Characteristics of Phase Compensation Films

A film forming solution with the nano-domain of Example 1 (without imbibed liquid crystal substance) and a film forming solution with a small scale functional material of the nano-domains of Example 1 imbibed with 22 wt. percent of Licristal® E44 are prepared as discussed herein (0.2 grams of the nano-domain of Example 1 or the small scale functional material suspended in 90 grams of toluene, 9.4 grams of dibutyl maleate, and 0.2 grams of BYK-320). Each of the two film forming solutions are used to form a film by a spin coating process, in which a 5 ml sample of the film forming solution is flooded onto a surface of a 10.16 cm diameter silicon wafer that is spun at 3,000 RPM for 90 seconds. The films are allowed to dry at room temperature and have a thickness of about 2 to about 7 micrometers.

The film formed with the nano-domains of Example 1 (without imbibed liquid crystal substance) have a refractive index of 1.4753 at 632.8 nm measured by a Metricon 2010 Prism coupler. The film formed with the small scale functional material having the nano-domains of Example 1 and imbibed with 22 wt. percent of Licristal® E44 have a refractive index of 1.5124 at 632.8 nm measured by a Metricon 2010 Prism coupler. This refractive index data suggests that the influence of the refractive index of a liquid crystal substance can be expressed in the optical characteristics of a film formed with the small scale functional material.

Compared to the film formed with the nano-domains of Example 1 (without imbibed liquid crystal substance), the film formed with the small scale functional material having the nano-domains of Example 1 imbibed with the 22 wt. % of Licristal® E44 produces a change in the refractive index of 0.037, which provides a significant phase retardation effect of about 185 nm. Additionally, this effect may be multiplied (or tuned according to the application) by adjusting a thickness of the film, e.g., a 23 μM thick film formed with the nano-domains and the small scale functional material discussed above can produce a phase retardation effect of 851 nm. This type of performance can provide for the application needs of a large portion of the liquid crystal display industry.

Range of Performance of Small Scale Functional Materials Imbibed with Liquid Crystals

Phase compensation films are usually characterized by their thickness (d=film thickness) and birefringence (Δn=film birefringence, where Δn*d=c(λ)*phase compensation, λ=wavelength, c(λ)=λ/(2*π)) and by the size and shape of index ellipsoids used in the film. The common use of Δn*d to express a metric of performance for a phase compensation film removes the wavelength dependence as well as a factor of 1/(2*π).

The birefringence of a film formed with the small scale functional material of the present disclosure will be governed by the birefringence of the liquid crystal and the amount (e.g., the weight fraction) of the liquid crystal substance in the nano-domain. The range of birefringence inherent to a liquid crystal substance is between Dn=0.02 to 0.5 with the expectation that liquid crystal substances are being continually improved upon and have many different classifications.

The range of amounts of the liquid crystal substance imbibed in the nano-domain, as discussed herein, can be in the range of about 10 wt. percent to about 20 wt. percent, but could be as high as about 60 wt. percent. In addition, the thickness of the film can vary from about 1 μm to about 50% n, but could be as thin as about 0.3 μm and as thick as about 150 μm. These parameters allow for phase compensation films with a high transparency (≧90 percent) and very low haze (<2 percent).

Within these boundaries the phase compensation films of the present disclosure can have characteristics of Δn*d in the range of 2 to 1,500 nm. The most practical values being some fraction of the phase retardation of the LCD that is being compensated, typically from about 10 to about 600 nm. Further, it is understood that a film with two or more layers each having, for example, a different liquid crystal substance, thickness, and/or predetermined index ellipsoid will be advantageous for a particular display type, (e.g., ASV (Advanced Super View), Bistable Nematic (BiNem), Cholesteric (or Chiral Nematic), ECB (Electrically Controlled Birefringence), FLCD (Ferroelectric Liquid Crystal Display), GH (Guest Host), IPS (In-Plane-Switching), LCoS (Liquid Crystal on Silicon), MVA (Multi-domain Vertical Alignment), PDLC (Polymer Dispersed Liquid Crystal), OCB (Optically Compensated Bend), PVA (Patterned Vertical Alignment), STN (Super Twisted Nematic), TN (Twisted Nematic), and Transflective mode displays).

So, it is possible that the small scale functional material of the present disclosure can address the performance needs in a commercially valuable sense for optical applications in the LCD industry.

### Control of Predetermined Index Ellipsoids

Embodiments of the present disclosure may be particularly useful in the LCD industry because of the need to tune proprietary liquid crystal cell designs for dark state, contrast ratio, color correction, and viewing angle requirements. The ability to provide control over the size, shape (e.g., type) and inclination of an index ellipsoid can be desirable attributes in a phase compensation film. The phase compensation films of the present disclosure can provide for control over the size, shape (e.g., type), and inclination of an index ellipsoid that is imbibed with a liquid crystal substance because of the inherent flexibility of the small scale functional material, its composition, and its cross-link density coupled with variability in liquid crystal type and amounts within the nano-domain.

Table 7 provides examples of index ellipsoids that are prepared from nano-domains and small scale functional materials provided herein. Film forming solutions for each of the examples is prepared as discussed herein (0.2 grams of the nano-domain of Example 1 or the small scale functional material suspended in 90 grams of toluene, 9.4 grams of dibutyl maleate, and 0.2 grams of BYK-320). Each of the film forming solutions is used to form films by the spin coating process, discussed above. A Metricon 2010 Prism coupler is used to measure the index of ellipsoid values for each of the resulting nano-domains and small scale functional materials that are used in forming the film. Each of the nano-domains of the examples in Table 7 has a volume mean diameter of 30 nm.

TABLE 7

| | | | | Liquid | | |
|---|---|---|---|---|---|---|
| | Nano- | Index | | Crystal | | Film |
| | Domain | Ellipsoid | Liquid Crystal | Amount | Δn * d | thickness |
| | Composition | Type | Substance | (wt. %) | (nm) | (μm) |
| Example | Example 1 | Uni-axial, | None | — | 16.8 | 7.8 |
| 32 | | Positive A- | | | | |
| | | plate, | | | | |
| | | nx > ny = nz | | | | |
| Example | Example 1 | Uni-axial, | BL006 | 18.1 | 3.2 | 6.2 |
| 33 | | Positive C- | | | | |
| | | plate, | | | | |
| | | nz > nx = ny | | | | |
| Example | Example 1 | Uni-axial, | 4-Cyano-4′- | 4.6 | 14.3 | 7.8 |
| 34 | | Negative | octylbiphenyl | | | |
| | | A-plate, | | | | |
| | | nx < ny = nz | | | | |
| Example | Example 1 | Uni-axial, | BL006 | 18.5 | 3.6 | 4.5 |
| 35 | | Negative | | | | |
| | | A-plate, | | | | |
| | | nx < ny = nz | | | | |
| Example | Example 1 | Uni-axial, | BL006 | 18.1 | 4.5 | 7.9 |
| 36 | | Negative | | | | |
| | | C-plate, | | | | |
| | | nx = ny > nz | | | | |
| Example | Example 1 | Bi-axial X- | 4-Cyano-4′- | 11.8 | 10.6 | 3.7 |
| 37 | | Y optical | octylbiphenyl | | | |
| | | axis, | | | | |
| | | nx > nz > ny | | | | |
| Example | Example 1 | Bi-axial, | 4-Cyano-4′- | 16.6 | 10.5 | 6.0 |
| 38 | | Positive, | octylbiphenyl | | | |
| | | Y-Z optical | | | | |
| | | axis, | | | | |
| | | nz > nx > ny | | | | |

The complete disclosures of all patents, patent applications including provisional patent applications, publications, and electronically available material cited herein or in the documents incorporated herein by reference. The foregoing detailed description and examples have been provided for clarity of understanding only. No unnecessary limitations are to be understood therefrom. The embodiments of the disclosure are not limited to the exact details shown and described; many variations will be apparent to one skilled in the art and are intended to be included within the disclosure defined by the claims.

1. A phase compensation film, comprising:
a particle having a cross-linked polymer domain with a largest dimension of 5 nm to 175 nm; and
a liquid crystal substance imbibed substantially throughout the cross-linked polymer domain of the particle to provide a phase compensation value for the phase composition film.

2. The film of claim 1, where the liquid crystal substance imbibed substantially throughout the cross-linked polymer domain of the particle provides a predetermined phase compensation value.

3. The film of claim 1, where the phase compensation film is ejection printed onto a pixel of a liquid crystal display.

4. The film of claim 1, where the cross-linked polymer domain has a predetermined index ellipsoid that allows the phase compensation film to compensate for an optical performance of a pixel of a liquid crystal display.

5. The film of claim 1, where the particle with the imbibed liquid crystal substance is dispersed spatially with varying concentrations in the phase compensation film to create a gradient of refractive indexes across a thickness of the phase compensation film.

6. The film of claim 1, where the particle and liquid crystal substance provide an individual phase compensation value at a pixel level for each of a first pixel, a second pixel, and a third pixel, where each of the first, second and third pixel provides a different color.

7. The film of claim 1, where the phase compensation film includes two or more layers that include the particle, where the liquid crystal substance imbibed substantially throughout the particle of each layer has a different internal birefringence than other layers that include the particle.

8. The film of claim 7, where the liquid crystal substance imbibed substantially throughout the particle is different in each of the two or more layers.

9. The film of claim 7, where the liquid crystal substance imbibed substantially throughout the particle has a percent by weight of the cross-linked polymer domain of the particle imbibed with the liquid crystal substance that is different in each of the two or more layers.

10. The film of claim 1, where the cross-linked polymer domain of the particle can form a predetermined index ellipsoid selected from the group of Positive A-plate, Negative A-plate, Positive C-plate, Negative C-plate, Positive Oblique type, Negative Oblique type, Biaxial X-Y optical axis, Biaxial Negative X-Z optical axis, and Biaxial Positive Y-Z optical axis.

11. A film forming composition, comprising:
a particle having a cross-linked polymer domain with a largest dimension of 5 nm to 175 nm;
a liquid crystal substance imbibed substantially throughout the cross-linked polymer domain of the particle; and
a liquid medium, where the liquid medium suspends the particle having the liquid crystal substance substantially throughout the cross-linked polymer domain of the particle.

12. The composition of claim 11, where the composition has a viscosity of a predetermined value to be used in at least one of thermal jetting, continuous jetting, piezo jetting, spray coating and Ink-Jet printing.

13. The composition of claim 11, where the composition can be applied at a size scale of a pixel for a liquid crystal display.

14. The composition of claim 11, where the cross-linked polymer domain of the particle can form a predetermined index ellipsoid selected from the group of Positive A-plate, Negative A-plate, Positive C-plate, Negative C-plate, Positive Oblique type, Negative Oblique type, Biaxial X-Y optical axis, Biaxial Negative X-Z optical axis, and Biaxial Positive Y-Z optical axis.

15. The composition of claim 11, where the liquid crystal substance imbibed substantially throughout the cross-linked polymer domain provides a phase compensation value in a range of 2 nm to 1500 nm.

16. A method of forming a phase compensation film, comprising:
applying a film forming composition to a substrate, where the film forming composition includes:
particles each having a cross-linked polymer domain with a largest dimension of 5 nm to 175 nm;
a liquid crystal substance imbibed substantially throughout the cross-linked polymer domain of the particles to provide a phase compensation value for the phase compensation film; and
a liquid medium, where the liquid medium suspends the particles imbibed therein with the liquid crystal substance.

17. The method of claim 16, where applying a film forming composition to a substrate includes applying the film forming composition to a pixel of a liquid crystal display.

18. The method of claim 16, where applying the film forming composition is through a surface coating technique selected from the group consisting of spray coating, Ink-Jet printing, film casting, thermal jetting, continuous jetting, and piezo jetting.

19. The method of claim 16, where applying the film forming composition includes applying the film forming composition with a first preselected liquid crystal substance to a first pixel of a liquid crystal display; and
applying film forming composition with a second preselected liquid crystal substance to a second pixel of the liquid crystal display.

20. (canceled)

21. The method of claim 16, including applying the film forming composition having different phase compensation values to individual pixels in a liquid crystal display.

22.-29. (canceled)
